(19) United States
(12) Patent Application Publication
(10) Pub. No.: US 2006/0012336 A1
(43) Pub. Date: Jan. 19, 2006

(54) Battery-pack voltage detection apparatus

(75) Inventor: Hiroshi Fujita, Kuwana-shi (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/178,362

(22) Filed: Jul. 12, 2005

(30) Foreign Application Priority Data
Jul. 12, 2004 (JP) 2004-204232
Nov. 11, 2004 (JP) 2004-327706

(51) Int. Cl. H02J 7/00

(52) U.S. Cl. 320/119

(57) ABSTRACT

In a battery-pack voltage detection apparatus, a voltage detection circuit is connected to N+1 potential terminals. N+1 switches each has at least first, second, and third continuous semiconductor regions with alternating conductivity type. The N+1 switches are configured to individually open/close the connections of the N+1 potential terminals and the voltage detection circuit. N+1 driving units are connected to at least one of the N+1 potential terminals and configured to apply at least one potential at at least one of the N+1 potential terminals to each of the N+1 switches to drive each of the N+1 switches.

### CROSS REFERENCE TO RELATED APPLICATIONS

This application is based on Japanese Patent Applications 2004-204232 and 2004-327706 filed on Jul. 12, 2004 and Nov. 11, 2004, respectively. This application claims the benefit of priority from these applications, so that the descriptions of which are all incorporated herein by reference.

### FIELD OF THE INVENTION

The present invention relates to the battery-pack voltage detection apparatus capable of detecting a voltage of each battery module constituting the battery pack.

### BACKGROUND OF THE INVENTION

For hybrid vehicles, electric vehicles, fuel-cell vehicles, and the like, batter packs have been used to maintain a desirable high voltage. Each battery pack is composed of many battery modules that are connected in series; each of the battery modules includes at least one of secondary cells or fuel cells.

The structure of battery pack allows its pack size (package size) to be kept compact. In addition, installation of the battery pack with a high voltage in the vehicles allows currents flowing to electric circuits therein to decrease, making it possible to reduce resistance losses produced by resistors in the electric circuits.

In such a battery pack, it is necessary to individually detect voltages of the battery modules in order to protect and manage the battery modules and to calculate capacitances thereof. For detecting the voltage of each battery module, battery-pack voltage detection apparatuses have been used.

As an example of such battery-pack voltage detection apparatuses, U.S. Pat. No. 6,362,627 B1 corresponding to Japanese Unexamined Patent Publication No. H11-248755 discloses a flying-capacitor type voltage measuring apparatus.

Specifically, as illustrated in FIG. 8 of the patent, a first multiplexer connects one of the terminals of one of serially connected voltage sources to one of the electrodes of a capacitor, and a second multiplexer connects the other of the terminals of the one of the voltage sources to the other of the electrodes of the capacitor. This allows a voltage between the terminals of one of the voltage sources to be applied to the capacitor.

Thereafter, when the first and second multiplexers are turned off and kept in OFF-state, the electrodes of the capacitor are connected to a voltage detecting circuit so that the voltage detecting circuit measures the voltage of one of the voltage sources based on a potential difference between the electrodes of the capacitor. After the measurement of one of the voltage sources, connection of the first and second multipliers is switched to another one of the voltage sources and, after that, the voltage between the terminals of another one of the voltage sources is measured as described above.

These voltage measurement operations are repeated until all of the voltages of the voltage sources are detected.

In the flying-capacitor type voltage measuring apparatus described above, it is necessary to repeat a series of operations a number of times corresponding to the number of voltage sources; this series of operations includes: (1) connection of the first and second multiplexers to one of the voltage sources, (2) application of a voltage of the one of the voltage sources to the capacitor, and (3) measurement of a potential difference between the electrodes of the capacitor.

This may increase the time needed to measure voltages of all battery modules in the battery pack. Increase of the measuring time may cause operating states of the battery pack to be changed during the measuring time; these operating states are represented by parameters, such as an output current, an output voltage, a temperature, and an SOC (State Of Charge) of the battery pack Note that the SOC means the available capacity rang in the battery pack, expressed as a percentage of the rated capacity.

The change of the operating states may cause errors between first values indicative of actual operating states of the battery pack and second values, which are correspondent to the operating states thereof and are calculated based on the measured voltages of the battery modules, to increase.

### SUMMARY OF THE INVENTION

The present invention has been made on the background above so that at least one preferable embodiment of the present invention provides a battery-pack voltage detection apparatus capable of reducing a time needed to measure a voltage of at least one battery module in a battery pack with keeping the apparatus's structure simple.

According to one aspect of the present invention, there is provided a battery-pack voltage detection apparatus connected to a batter pack the battery pack comprising N series connected battery modules, the N being an integer equal to or more than 2; and N+1 potential terminals corresponding to a highest potential, a lowest potential, and N−1 intermediate potentials of the N series battery modules. The battery-pack voltage detection apparatus comprises a voltage detection circuit connected to the N+1 potential terminals; N+1 switches each having at least first, second, and third continuous semiconductor regions with alternating conductivity type, the N+1 switches being configured to individually open/close the connections of the N+1 potential terminals and the voltage detection circuit; and N+1 driving units connected to at least one of the N+1 potential terminals and configured to apply at least one potential at at least one of the N+1 potential terminals to each of the N+1 switches to drive each of the N+1 switches.

According to another aspect of the present invention, there is provided a battery-pack voltage detection apparatus connected to a battery pack, the battery pack comprising a plurality of battery modules connected in series, and a plurality of voltage output terminals connected to positive terminals of the battery modules, respectively. The battery-pack voltage detection apparatus comprises a voltage detection circuit connected to the plurality of voltage output terminals; a plurality of switches each having at least a charge carrier emitting region, a control region, and a charge carrier collection region continuously arranged with alternating conductivity type; and a plurality of current path forming circuits including chare carrier pull-out elements. Each of the charge carrier pull-out elements connects between the charge carrier emitting region and the control region of each of the switches. The current path forming circuits form a plurality of current paths from the plurality of voltage output terminals through the plurality of charge carrier pull-out elements, respective.

According to a further aspect of the present invention, there is provided a battery-pack voltage detection apparatus connected to a battery pack, the battery pack comprising a plurality of battery modules connected in series; and a plurality of pairs of terminals, each pair of the terminals corresponding to a voltage output terminal of each of the battery modules. The battery-pack voltage detection apparatus comprises a voltage detection circuit with first and second input terminals. The voltage detection circuit is configured to detect a potential difference between the first and second terminals; a voltage applying circuit having a plurality of switching elements connected between the terminals and any one of the first and second input terminals of the voltage detection circuit, respectively. Each of the switching element has a control terminal connected to any one of the first and second input terminals thereof and operating to turn on/off based on a voltage applied to the control terminal. The voltage applying circuit is configured to selectively tun on any one pair of the switching elements to select any one pair in the plurality of pairs of terminals of the battery pack; and connect the selected pair of terminals to the first and second input terminals to apply a voltage of one of the batter modules corresponding to the selected pair of terminals to the voltage detection circuit. The battery-pack voltage detection apparatus also comprises a reference voltage applying circuit is connected to the first and second input terminals of the voltage detection circuit and configure to fix any one of the first and second input terminals to a predetermined reference voltage when the voltage applying circuit connects the selected pair to the fit and second input terminals of the voltage detection circuit.

In the aspects of the present invention, the term “battery module” means a power supply module composed of at least one electric cell. In the aspects of the present invention, the term “connection (connected, connect)” means a direct connection and an indirect connection through another element (circuit), such as an electric connection.

### BRIEF DESCRIPTION OF THE DRAWINGS

Other objects and aspects of the invention will become apparent from the following description of embodiments with reference to the accompanying drawings in which:

FIG. 1 is a circuit diagram of a battery-pack voltage detection apparatus according to a first embodiment of the present invention;

FIG. 2 is an enlarged view of an area in which P-channel MOSFETs and first N-channel MOSFETs are arranged according to the first embodiment;

FIG. 3 is a circuit diagram of a battery-pack voltage detection apparatus according to a second embodiment of the present invention;

FIG. 4 is a circuit diagram of a battery-pack voltage detection apparatus according to a third embodiment of the present invention;

FIG. 5 is an enlarged view of an area in which a MOSFET drive section is arranged according to the third embodiment;

FIG. 6 is a circuit diagram of a battery-pack voltage detection apparatus according to a fourth embodiment of the present invention;

FIG. 7 is a circuit diagram of a battery-pack voltage detection apparatus according to a fifth embodiment of the present invention;

FIG. 8 is a circuit diagram of a battery-pack voltage detection apparatus according to a sixth embodiment of the present invention;

FIG. 9 is a circuit diagram of a battery-pack voltage detection apparatus according to a seventh embodiment of the present invention; and

FIG. 10 is a circuit diagram of a battery-pack voltage detection apparatus according to an eighth embodiment of the present invention.

### DETAILED DESCRIPTION OF EMBODIMENTS OF THE INVENTION

Embodiments of the present invention will be described hereinafter with reference to the accompanying drawings. In each embodiment, a battery-pack voltage detection apparatus is designed for hybrid vehicles.

### First Embodiment

An example of the structure of a battery-pack voltage detection apparatus according to a first embodiment of the present invention will be described hereinafter.

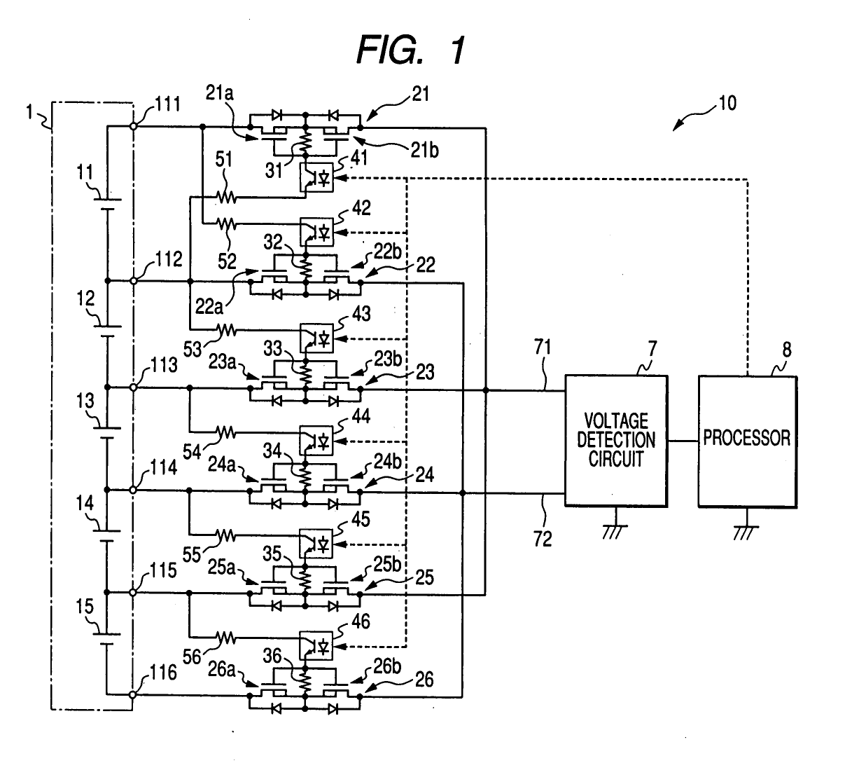

FIG. 1 illustrates an example of the circuit diagram of a battery-pack voltage detection apparatus 10 installed in a hybrid vehicle (not shown) according to the first embodiment. As shown in FIG. 1, the battery-pack voltage detection apparatus, which is referred to simply as voltage detection apparatus, 10 is provided with a voltage detection it 7 with first and second input terminal 71 and 72.

The voltage detection apparatus 10 is also provided with a pair of P-channel MOSFETs (Metal Oxide Semiconductor Field Effect Transistors) 21 (21a, 21b) whose sources are commonly connected to each other. The voltage detection apparatus 10 is further prided with a first pair of N-charnel MOSFETs 22 (22a, 22b) to a fifth pair of N-channel MOSFETs 26 (26a, 26b), first to sixth discharging resistors 31 to 36, first to sixth photocouplers 41 to 46, first to sixth voltage-dividing resistors 51 to 56, and a processor 8.

A battery pack 1 as a target of voltage measurement is equipped with a first battery block (battery module) 11 to a fifth battery block (battery module) 15, a highest potential terminal 111, a lowest potential terminal 116, and first to fourth intermediate potential terminals 112 to 115.

Each of the first to fifth battery blocks 11 to 15 includes at least one of electric cells, such as secondary cells, fuel cells, or the like.

The first to fifth battery blocks 11 to 15 are connected to each other in series. The highest potential terminal 111 is connected to the high-side terminal of the first battery block 11, and the lowest potential terminal 116 is connected to the low-side terminal of the fifth battery block 15.

The first intermediate potential terminal 112 is connected to the low-side teal of the first battery block 11 and to the high-side ter of the second battery block 12. The second intermediate potential terminal 113 is connected to the low-side terminal of the second battery block 12 and to the high-side terminal of the third battery block 13. The third intermediate potential terminal 114 is connected to the low-side terminal of the third battery block 13 and to the high-side terminal of the fourth battery block 14. The fourth intermediate potential terminal 115 is connected to the low-side terminal of the fourth battery block 14 and to the high-side terminal of the fifth battery block 15.

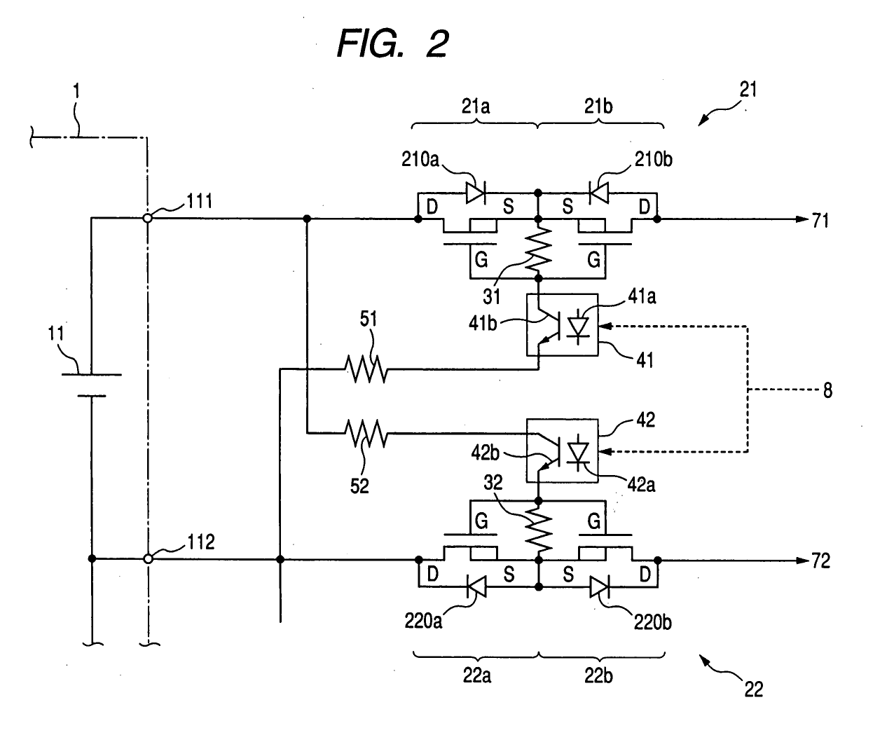

FIG. 2 is an enlarged view of an area in which the P-channel MOSFETs 21 (21a, 21b) and the first N-channel MOSFETs 22 (22a, 22b) are arranged. As illustrated in FIG. 2, the P-channel MOSFETs 21a, 21b are configured to control open/close of a line between the highest potential terminal 111 and the first input terminal 71 of the voltage detection circuit 7.

Specifically, the drain D of the P-channel MOSFET 21a is connected to the highest potential terminal 111. The P-channel MOSFET 21a has an intrinsic diode 210a between the drain D and the source S thereof. The anode of the intrinsic diode 210a is arranged to the drain side of the P-channel MOSFET 21a, and the cathode of the diode 210a is arranged to the source side of the MOSFET 21a.

The drain D of the P-channel MOSFET 21b is connected to the first input terminal 71 of the voltage detection circuit 7. The P-channel MOSFET 21b has an intrinsic diode 210b between the drain D and the source S thereof. The anode of the intrinsic diode 210b is arranged to the drain side of the P-channel MOST 21b, and the cathode of the diode 210b is arranged to the source side of the MOSFET 21b. The source S of the P-channel MOSFET 21a and that of the P-channel MOSFET 21b are commonly connected to each other.

The first discharging resistor 31 is configured to discharge charges stored between the gate G and the source S of each of the P-channel MOSFETs 21a and 21b. Specifically, one end of the first discharging resistor 31 is connected to the common source of each of the P-channel MOSFETs 21a and 21b. The other end of the first discharging resistor 31 is connected to both the gate G of the P-channel MOSFET 21a and that of the P-channel MOSFET 21b.

The first photocoupler 41 is configured to apply the potential at the first intermediate terminal 112 to the gate G of each of the P-channel MOSFETs 21a and 21b. Specifically, the first photocoupler 41 is provided with an LED (Light Emitting Diode) 41a and a phototransistor 411b. The first photocoupler 41 is connected to the processor 8 such that the processor 8 allows the first photocoupler 41 to turn on or off. The collector of the phototransistor 41b is connected to the other end of the first discharging resistor 31, and the emitter thereof is connected to the first intermediate terminal 112 through the first voltage-dividing resistor 51.

Similarly as shown in FIG. 2, the first N-channel MOSFETs 22 (22a, 22b) are configured to control open/close of a line between the fist intermediate potential terminal 112 and the second input terminal 72 of the voltage detection circuit 7.

Specifically, the drain D of the first N-channel MOSFET 22a is connected to the first intermediate potential terminal 112. The first N-channel MOS 22a has an intrinsic diode 220a between the drain D and the source S thereof. The cathode of the intrinsic diode 220a is arranged to the drain side of the first N-channel MOSFET 22a, and the anode of the diode 220a is arranged to the source side of the MOSFET 22a.

The drain D of the first N-channel MOSFET 22b is connected to the second input terminal 72 of the voltage detection circuit 7. The first N-channel MOSFET 22b has an intrinsic diode 220b between the drain D and the source S thereof. The cathode of the intrinsic diode 220b is arranged to the drain side of the first N-channel MOSFET 22b, and the anode of the diode 220b is arranged to the source side of the MOSFET 22b. The source S of the first N-channel MOSFET 22a and that of the first N channel MOSFET 22b are commonly connected to each other.

The second discharging resistor 32 is configured to discharge charges stored between the gate G and the source S of each of the first N-channel MOSFETs 22a and 22b. Specifically, one end of the second discharging resistor 32 is connected to the common source of each of the first N-channel MOSFETs 22a and 22b. The other end of the second discharging resistor 32 is connected to both the gate G of the first N-channel MOSFET 22a and that of the first N-channel MOSFET 22b.

The second photocoupler 42 is configured to apply the potential at the highest potential terminal 111 to the gate G of each of the first N-channel MOSFETs 22a and 22b. Specifically, the second photocoupler 42 has an LED 42a and a phototransistor 42b. The second photocoupler 42 is connected to the processor 8 such that the processor 8 allows the second photocoupler 42 to turn on or off. The emitter of the phototransistor 42b is connected to the other end of the second discharging resistor 32 in series, and the collector thereof is connected to the highest potential terminal 111 through the second voltage dividing resistor 52.

Turning to FIG. 1, ah of the remaining second to fifth N channel MOSFETs 23 (23a, 23b) to 26 (26a, 26b) has a substantially identical structure of the first N-channel MOSFET 22, and substantially identical connections thereof.

Specially, the sources of each pair of the second to fifth N-channel MOSFETs 23 to 26 are commonly connected to each other. The drains of the N-channel MOSFETs 23a to 25a are connected to the second to fourth intermediate potential terminals 113 to 115, respectively. The drain of the N-channel MOSFET 26a is connected to the lowest potential terminal 116.

The drains of the N-channel MOSFETs 23b and 25b are connected to the drain of the P-channel MOSFET 21b to be merged as a single output, and the single output is connected to the first input terminal 71 of the voltage detection circuit 7, which is referred to, for example, as “multiplex connection”. Similarly, the drains of the N-channel MOSFETs 24b and 26b are connected to the drain of the N-channel MOSFET 22b to be merged as a since output, and the single output is connected to the second input terminal 72 of the voltage detection circuit 7 in the multiplex connection.

Specifically, the drains of the MOSFETs 21b, 23b, and 25b, are multiplex-connected to the first input terminal 71 of the voltage detection circuit 7, and the drains of the MOSFETs 22b, 24b, and 26b are multiplex-connected to the second input terminal 72 of the voltage detection circuit 7.

The gates of the second to fifth N-channel MOSFETs 23 to 26 are connected to the first to fourth intermediate potential terminals 112 to 115 through the third to sixth photocouplers 43 to 46 and the third to sixth voltage dividing resistors 53 to 56, respectively.

The voltage detection circuit 7 is provided with a voltage amplifier and an analog-to-digital (A/D) converter, which are not illustrated in FIG. 1. The voltage detection circuit 7 is grounded to the chassis of the hybrid vehicle. The voltage amplifier is connected to both the first and second input terminals 71 and 72 and configured to amplify a difference between each of the potentials at the potential terminals 111 to 116, which are input to any one of the first and second input terminals, and a predetermined reference voltage. The A/D converter is operative to convert an output voltage signal corresponding to the amplified result and sent from the voltage amplifier into digital data (voltage data).

The processor 8 is connected to the voltage detection circuit 7 and operative to compute the SOC of the battery pack 1 based on the digital voltage data sent from the voltage detection circuit 7. The processor 8 is grounded to the chassis of the hybrid vehicle. In addition, the processor 8 is connected to the LEDs of the photocouplers 41 to 46 and operative to control to turn on/off the LEDs. In addition, the processor 8 is operative to control to turn on/off analog switches (not shown) and control sampling timings of A/D converters (not shown).

Next, operations of the voltage detection apparatus 10 according to the firs embodiment will be described hereinafter. As an example, operations of the voltage detection apparatus 10 for measuring a voltage of the first battery block 11 will be described with reference to FIG. 2.

When measuring the potential at the highest potential terminal 111, the processor 8 controls to turn on the photocoupler 41 (the phototransistor 41b). The On state of the photocoupler 41 allows a current to flow between the highest potential terminal 111 and the first intermediate potential terminal 112 in the order of the highest potential terminal 111, the intrinsic diode 210a, the first discharging resistor 31, the phototransistor 41b, the first voltage-dividing resistor 51, and the fast intermediate potential terminal 112. The current permits a voltage to be applied to the gate G of each of the P-channel MOSFETs 21a and 21b based on the voltage of the first battery block 11.

The current through the first discharge resistor 31 causes a voltage drop of the gate G of each of the P-channel MOSFET 21a and 21b, thereby decreasing the potential of the gate G of each of the P-channel MOSFETs 21a and 21b with respect to the potential of the source S thereof. When the voltage drop of the gate G of each of the P-channel MOSFETs 21a and 21b is higher than a threshold voltage of each of the P-channel MOSFETs 21a and 21b, each of the P-channel MOSFETs 21a and 21b is turned on. This brings the drain-source path of the MOSFET 21a and the source-drain path of the MOSFET 21b into conduction.

This results in that the potential at the highest potential t 111 is applied to the first input terminal 71 of the voltage detection circuit 7. Note that the potential, referred to as “VG1”, at the gate G of each of the MOSFETs 21a and 21b is represented by the following equation:
VG1=VB1×r1/(R1+r1)
where VB1 represents the voltage of the first battery block 11, R1 represents a resistance of the first discharging resistor 31, and r1 represents a resistance of the first voltage-dividing resistor 51.

After the potential at the highest potential terminal 111 has been measured, the processor 8 controls to turn off the photocoupler 41, which allows charges stored between the gate G and the source S of each of the P-channel MOSFETs 21a and 21b to be discharged (pulled out) through the first discharging resistor 31. This causes each of the P-channel MOSFETs 21a and 21b to turn off.

When measuring the potential at the first intermediate potential terminal 112, the processor 8 controls to switch the photocoupler 42 (the phototransistor 42b) on. The On-state of the photocoupler 42 permits a current to flow between the highest potential terminal 111 and the first intermediate potential terminal 112 in the order of the highest potential terminal 111, the second voltage-dividing resistor 52, the phototransistor 42b, the second discharging resistor 32, the intrinsic diode 220a, and the first intermediate potential terminal 112. The current enables a voltage to be applied to the gate G of each of the first N-channel MOSFETs 22a and 22b based on the voltage of the first battery block 11.

The current through the second discharge resistor 32 causes a voltage drop of the source S of each of the first N-channel MOSFETs 22a and 22b, thereby making the potential of the gate G of each of the first N-channel MOSFETs 22a and 22b higher than the potential of the source S thereof. When the voltage drop of the source S of each of the N-channel MOSFETs 22a and 22b is higher than a threshold voltage of each of the N-channel MOSFETs 22a and 22b, each of the N-channel MOSFETs 22a and 22b is turned on. This brings the drain-source path of the MOSFET 22a and the source-drain path of the NOSE 22b into conduction.

This results in that the potential at the first intermediate potential terminal 112 is applied to the second input terminal 72 of the voltage detection circuit 7. Note that the potential, referred to as “VG2”, at the gate G of each of the MOSFETs 22a and 22b is represented by the following equation:
VG2=VB2×r2/R2+r2)
where R2 represents a resistance of the second discharging resistor 32, and r2 represents a resistance of the second voltage-dividing resistor 52.

After the potential at the first intermediate potential terminal 112 has been measured, the processor 8 controls to turn off the photocoupler 42, which enables charges stored between the gate G and the source S of each of the first N-channel MOSFETs 22a and 22b to be discharged (pulled out) through the second discharging resistor 32. This causes each of the first N-channel MOSFETs 22a and 22b to turn off.

The voltage detection circuit 7 measures the voltage of the battery block 11 based on the difference between the potential at the highest potential terminal 111 and that at the first intermediate potential terminal 112.

The potential measuring operations set forth above are sequentially performed with respect to the remaining second to fourth intermediate potential terminals 113 to 115 and the lowest potential terminal 116 so that potentials at the potential terminals 113 to 116 are measured by the voltage detection circuit 7. For example, a potential at the potential terminal 114 is applied to the gate G of each of the fourth N-channel MOSFETs 25a and 25b with the fifth photocoupler 45 being turned on so that the drain-source path of the MOSFET 25a and the source-drain path of the MOSFET 25b are conducted. This allows the potential at the fourth intermediate potential terminal 115 to be applied to the first input terminal 71 of the voltage detection circuit 7.

Specifically, the voltage detection circuit 7 measures voltages of the remaining battery blocks 12 to 15 based on the potentials of the potential terminals 112 to 116.

Next, effects obtained by the voltage detection apparatus 10 according to the first embodiment will be described hereinafter.

Specifically, the voltage detection apparatus 10 according to the first embodiment uses the potential at any one of the potential terminals 111 to 116 in the battery pack 1 to drive the gate of each of the MOSFETs 21 to 26. This allows the switching speed of each of the MOSFETs 21 to 26 to be higher as compared with using electromotive voltages generated by photoelectric elements composed of LEDs and photodiodes in array for driving the gate of each of the MOSFETs.

The reason will be described hereinafter.

That is, it is assumed that each of the photoelectric elements is so configured that the photodiode can generate an electromotive voltage depending on light intensity of the corresponding LED. In addition, it is assumed that each of the photoelectric elements is so arranged that the photodiode can apply the electromotive voltage generated thereby to the gate of each of the MOSFETs 21 to 26.

In these assumptions, the lower the resistance of each discharging resistor is, the shorter the turnoff time of each MOSFET, but the longer the turn-on time thereof. This is because it is likely that, when each MOSFET is turned on, a current generated based on the electromotive voltage of each photoelectric element will flow into each discharging resistor, preventing the gate of each MOSFET from being charged.

It is likely that use of the photoelectric elements for driving the gate of each of the MOSFETs 21 to 26 therefore requires a gate control circuit for charging and discharging charges between the gate G and the source S of each of the MOSFETs 21 to 26 in order to reduce the turn-on time and the turn-off time of each MOSFET.

In contrast, in these assumptions, the higher the resistance of each discharging resistor is, the shorter the turn-on time of each MOSFET, but the longer the turn-off time thereof. This is because it is probably that, when each MOSFET is turned off, the charge consumption rate of each discharging resistor gets late.

On the contrary, in the voltage detection apparatus 10 of the present invention, the lower the resistance of each of the first to sixth discharging resistors 31 to 36, the shorter both the turn-on time and the turnoff time of each of the MOSFETs 21 to 26 are.

That is, in the voltage detection apparatus 10, a current flowing through each of the first to such discharging resistors 31 to 36 allows each MOSFET to turn on. The lower the resistance of each of the discharging resistors 31 to 36 therefore, the more easily the current flows through each of the first to sixth discharging resistors 31 to 36, making it possible to reduce the turn-on time of each MOSFET.

In addition, the lower the resistance of each of the discharging resistors 31 to 36, the more rapidly the charges stored between the gate G and the source S (gate-source capacitor) of each MOSFET is discharged, permitting the turn-off time of each MOSFET to decrease.

As described above, the voltage detection apparatus 10 allows the turn-on time and the turn-off time of each of the MOSFETs 21 to 26 to decrease without using such a gate control circuit, thereby easily increasing the switching speed of each of the MOSFETs 21 to 26.

This makes it possible to reduce the time needed to measure voltages of all battery blocks 11 to 15 in the battery pack 1 with keeping the circuit structure of the apparatus 10 simple. This can reduce possibilities of changes of the battery pack's operating states during measurement of the voltages of all battery blocks 11 to 15.

In addition, the voltage detection apparatus 10 according to the first embodiment uses the intrinsic diode 210a of the P-channel MOSFET 21a as a factor of the current path formed between the highest potential terminal 111 and the first intermediate potential final 112 through the P-channel MOSFET 21a.

Similarly, the voltage detection apparatus 10 uses the intrinsic diode 220a of the first N-channel MOSFET 22a as a factor of the current path formed between the highest potential terminal 111 and the first intermediate potential terminal 112 through the first battery block 11 and the first N channel MOSFET 22a. The voltage detection apparatus 10 uses the intrinsic diode of the second N-channel MOSFET 23a as a factor of the current path formed between the first intermediate potential terminal 112 and the second intermediate potential terminal 113 through the second battery block 12 and the second N-channel MOSFET 23a.

The voltage detection apparatus 10 uses the intrinsic diode of the third N channel MOSFET 24a as a factor of the current path formed between the second intermediate potential terminal 113 and the third intermediate potential terminal 114 through the third battery block 13 and the third N-channel MOSFET 24a. The voltage detection apparatus 10 uses the intrinsic diode of the fourth N-channel MOSFET 25a as a factor of the current path formed between the third intermediate potential terminal 114 and the fourth intermediate potential terminal 115 through the fourth battery block 14 and the fourth N-channel MOSFET 25a. The voltage detection apparatus 10 uses the intrinsic diode of the fifth N-channel MOSFET 26a as a factor of the current path formed between the fourth intermediate potential terminal 115 and the fifth intermediate potential terminal 116 through the fifth battery block 15 and the fifth N-channel MOSFET 26a.

Use of each intrinsic diode of each MOSFET as a factor of each current path therethrough makes it possible to reduce the number of elements of the voltage detection apparatus 10 and simplify the circuit structure thereof as compared with a voltage detection apparatus using another diode serving as a factor of each current path through each MOSFET.

Moreover, the voltage detection apparatus 10 according to the first embodiment is provided with the P-channel MOSFETs 21a and 21b whose sources are commonly connected to each other, and the first N-channel MOSFETs 22a and 22b whose sources are commonly connected to each other to the f N-channel MOSFETs 26a and 26b whose sources are commonly connected to each other. This structure prevents current leakage into the battery pack side during voltage measurement.

Specifically, in the voltage detection apparatus 10, one P-channel MOSFET 21b, one second N-channel MOSFET 23b, and one fourth Noel MOSFET 25b are connected in common with the first input terminal 71 of the voltage detection circuit 7. This may cause, when, for example, measuring the potential at the highest potential terminal 111, current leakage into the N-channel MOSFETs 23b and 25b.

In the voltage detection apparatus 10, however, the other N-channel MOSFETs 23a and 25a are arranged such that the sources S thereof are connected to those of the N-channel MOSFETs 23b and 25b. This structure prevents the current leakage into each of the N-channel MOSFETs 23b and 25b from flowing into the battery pack 1.

Similarly, in the voltage detection apparatus 10, one first N-channel MOSFET 22b, one third N-channel MOSFET 24b, and one fifth N-channel MOSFET 26b are connected in common with the second input terminal 72 of the voltage detection circuit 7. This may cause, when, for example, measuring the potential at the first intermediate potential terminal 112, current leakage into the N-channel MOSFETs 24b and 26b.

In the voltage detection apparatus 10, however, the other N-channel MOSFETs 24a and 26a are arranged such that the sources S thereof are connected to those of the N-channel MOSFETs 24b and 26b. This structure prevents the current leakage into each of the N-channel MOSFETs 24b and 26b from flowing to the battery pack 1.

In addition, when, for example, measuring the potential at the intermediate potential terminal 113 or 115, because the other P-channel MOSFET 21a is arranged such that the source S thereof is connected to that of the P-channel MOSFET 21b, the current leakage into the P-channel MOSFET 21b is prevented from flowing to the batty pack 1. Similarly, when, for example, measuring the potential at the intermediate potential terminal 114 or the lowest potential terminal 116, because the other N-channel MOSFET 22a is arranged such that the source S thereof is connected to that of the N-channel MOSFET 22b, the current leakage into the N channel MOSFET 22b is prevented from flowing to the battery pack 1.

Furthermore, in the voltage detection apparatus 10, the first, second, and third photocouplers 41, 42, and 43 are arranged between the P-channel MOSFETs 21 and the first intermediate potential terminal 112, between the highest potential terminal 111 and the first N-channel MOSFETs 22, and between the first intermediate potential terminal 112 and the second N-channel MOSFETs 23, respectively. Similarly, in the voltage detection apparatus 10, the fourth, fifth, and sixth photocouplers 44, 45, and 46 are arranged between the second intermediate potential terminal 113 and the third N-channel MOSFETs 24, between the third intermediate potential terminal 114 and the fourth N-channel MOSFETs 25, and between the fourth intermediate potential terminal 115 and the sixth N-channel MOSFETs 26, respectively.

This structure allows a stable voltage with low impedance to be applied to the gate G of each of the MOSFETs 21 to 26, g it possible to increase the switching speed of each of the MOSFETs 21 to 26.

In addition, each of the first to sixth discharging resistors 31 to 36 is arranged between the gat G and the source S of each of the MOSFETs 21 to 26, which allows charges stored in the gate-source capacitor of each of the MOSFETs 21 to 26 to be rapidly discharged (pulled out). It is possible therefore to father increase the switching speed of each of the MOSFETs 21 to 26.

Still furthermore, in the voltage detection apparatus 10, the first to sixth photocouplers 41 to 46 are used to drive the gate G of each of the MOSFETs 21 to 26. This makes it possible to easily provide secure electrical-isolation between a high voltage system including the battery pack 1 and a low voltage system including the voltage detection circuit 7 and the processor 8.

In the voltage detection apparatus 10, an odd number of, such as five (first to fifth), voltage blocks 11 to 15 are arranged, and the P-channel MOSFETs 21 is connected to the highest potential terminal 111. In addition, the fifth N-channel MOSFETs 26 are connected to the lowest potential terminal 116, and the first to fourth intermediate potential terminals 112 to 115 are connected to the first to fourth N-channel MOSFETs 22 to 25, respectively. This structure allows any one of the MOSFETs 21 to 26 to open/close any one of the potential terminals 111 to 116.

### Second Embodiment

A difference point between the structure of a battery-pack voltage detection apparatus 10A according to a second embodiment of the present invention and that of the battery-pack voltage detection apparatus 10 according to the first embodiment is that a single P-channel MOSFET 21b is disposed in the voltage detection apparatus 10A in place of the P-channel MOSFETs 21. Another difference point between the structure of the voltage detection apparatus 10A and that of the voltage detection apparatus 10 is that a single N-channel MOSFET 26b is disposed in the voltage detection apparatus 10A in place of the N channel MOSFETs 26.

Other remaining elements of the voltage detection apparatus 10A are substantially identical with those of the voltage detection apparatus 10 according to the first embodiment. To the remaining elements of the voltage detection apparatus 10A and the corresponding elements of the voltage detection apparatus 10 therefore, the same reference characters are assigned. The difference points therefore will be mainly described hereinafter.

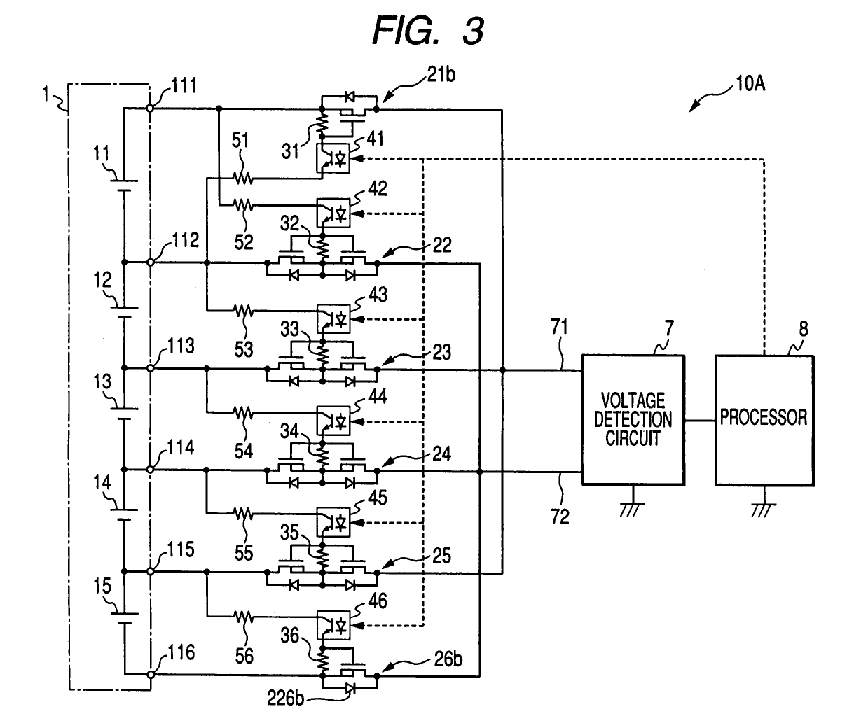

Specifically, as illustrated in FIG. 3, the source of the P-channel MOSFET 21b is connected to the highest potential terminal 111, and the drain thereof is connected to the first input terminal 71 of the voltage detection circuit 7. In addition, one end of the first discharge resistor 31 is connected to the source of the P-channel MOSFET 21b, and the other thereof is connected to the gate of the P-channel MOSS 21b.

Moreover, the source of the fifth N-channel MOSFET 26b is connected to the lowest potential terminal 116, and the drain thereof is connected to the second input terminal 72 of the voltage detection circuit 7. In addition, the gate of the fifth N-channel MOSFET 26b is connected to the fourth intermediate potential terminal 115 through the sixth photocoupler 46 and the sixth voltage-dividing resistor 56.

In the voltage detection apparatus 10A according to the second embodiment, when the first photocoupler 41 is turned on to measure the potential at the highest potential terminal 111, a current flows directly from the highest potential terminal 111 to the first discharging resistor 31.

Similarly, when the sixth photocoupler 46 is turned on to measure the potential at the lowest potential terminal 116, a current flows from the fourth intermediate potential terminal 115 to the lowest potential terminal through the sixth voltage-dividing resistor 56, the so photocoupler 46, the sixth discharging resistor 36.

The remaining operations of the voltage detection apparatus 10A according to the second embodiment are substantially the same as the vole detection apparatus 10 according to the first embodiment. This allows the voltage detection apparatus 10A according to the second embodiment to have substantially the same effects as the voltage detection apparatus 10.

In addition, in the voltage detection apparatus 10A, when, for example, measuring the potential at the intermediate potential terminal 113 or 115, the source of the P-channel MOSFET 21b is biased by the potential of the positive electrode of the first battery block 11, which is the highest in the potentials in the battery pack 1. This makes it possible to prevent current leakage from flowing to the battery block 11.

Moreover, in the voltage detection apparatus 10A, when, for example, measuring the potential at the intermediate potential terminal 112 or 114, the cathode of the intrinsic diode 226b of the fifth N-channel MOSFET 26b is connected to the second input terminal 72 of the voltage detection circuit 7. The OFF-state of the fifth N-channel MOSFET 26b and the intrinsic diode 226b make it possible to prevent current leakage from flowing to the battery block 15.

The voltage detection apparatus 10A according to the second embodiment therefore has a further effect of reducing the number of P-channel MOSFETs and N-channel MOSFETs, making the structure of the voltage detection apparatus 10A more compact.

### Third Embodiment

A difference point between the structure of a battery-pack voltage detection apparatus 105 according to a third embodiment of the present invention and that of the bates-pack voltage detection apparatus 10 is that a MOSFET drive section including bipolar transistors is disposed in the voltage detection apparatus 10B in place of the photocouplers 41 to 46. Another difference point between the structure of the voltage detection apparatus 10B and that of the voltage detection apparatus 10 is that two pairs of P-channel MOSFETs are disposed in the voltage detection apparatus 10B in place of the first and second N-channel MOSFETs 22 and 23.

Other remaining elements of the voltage detection apparatus 10B are substantially identical with those of the voltage detection apparatus 10 according to the first embodiment. To the rang elements of the voltage detection apparatus 10B and the corresponding elements of the voltage detection apparatus 10 therefore, the same reference characters are assigned. The difference points therefore will be mainly described hereinafter.

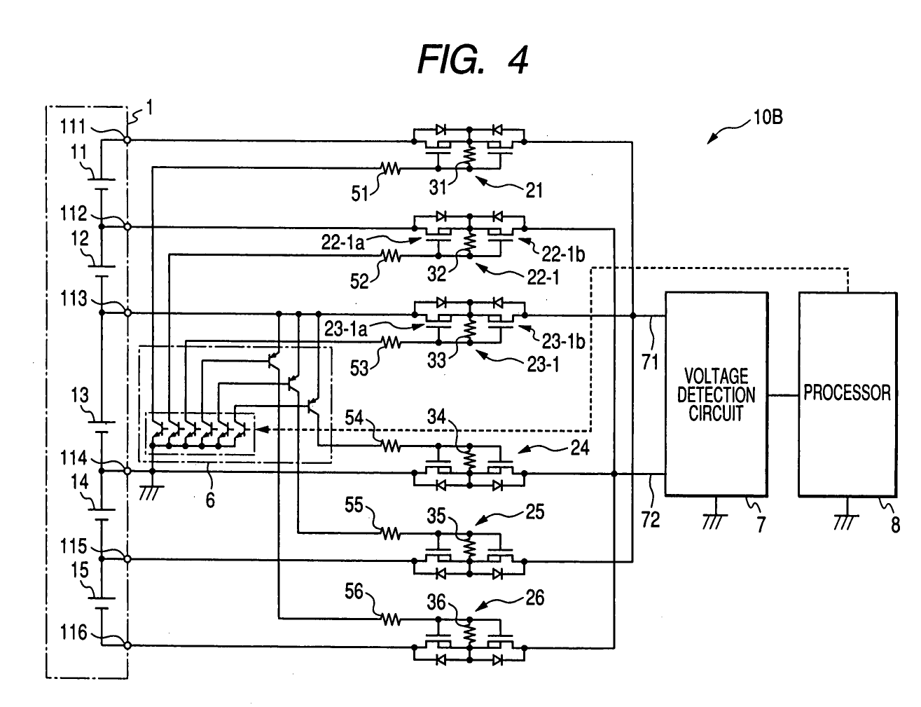

FIG. 4 illustrates an example of the circuit diagram of the voltage detection apparatus 10B according to the third embodiment. Specifically, the P-channel MOSFETs 22-1 (22-1a, 22-1b) are configured to control open/close of the line between the first intermediate potential terminal 112 and the second input terminal 72 of the voltage detection circuit 7.

The drain of the P-channel MOSFET 22-1a is connected to the first intermediate potential terminal 112. The P-channel MOST 22-1a has an intrinsic diode between the drain and the source thereof like the intrinsic diode 210a of the P-channel MOSFET 21a.

The drain of the P-channel MOSFET 22-1b is connected to the second input terminal 72 of the voltage detection circuit 7. The P-channel MOSFET 22-1b has an intrinsic diode between the drain and the source thereof like the intrinsic diode 210b of the P-channel MOSFET 21b.

One end of the second discharging resistor 32 is connected to the common source of each of the P-channel MOSFETs 22-1a and 22-1b. The other end of the second discharging resistor 32 is connected to both the gate of the P-channel MOSFET 22-1a and that of the P-channel MOSFET 22-1b.

Similarly, the P-channel MOSFETs 23-1 (23-1a, 23-1b) are configured to control open/close of the line between the second intermediate potential terminal 113 and the first input terminal 71 of the voltage detection circuit 7.

The drain of the P-channel MOSFET 23-1a is connected to the second intermediate potential terminal 113. The P-channel MOSFET 23-1a has an intrinsic diode between the drain and the source thereof like the intrinsic diode 210a of the P-channel MOSFET 21a.

The drain of the P-channel MOSFET 23-1b is connected to the first input terminal 71 of the voltage detection circuit 7. The P-channel MOSFET 23-1b has an intrinsic diode between the drain and the source thereof like the intrinsic diode 210b of the P-channel MOSFET 21b.

One end of the third discharging resistor 33 is connected to the common source of each of the P-channel MOSFETs 23-1a and 23-1b. The other end of the third discharging resistor 33 is connected to both the gate of the P-channel MOSFET 23-1a and that of the P-channel MOSFET 23-1b.

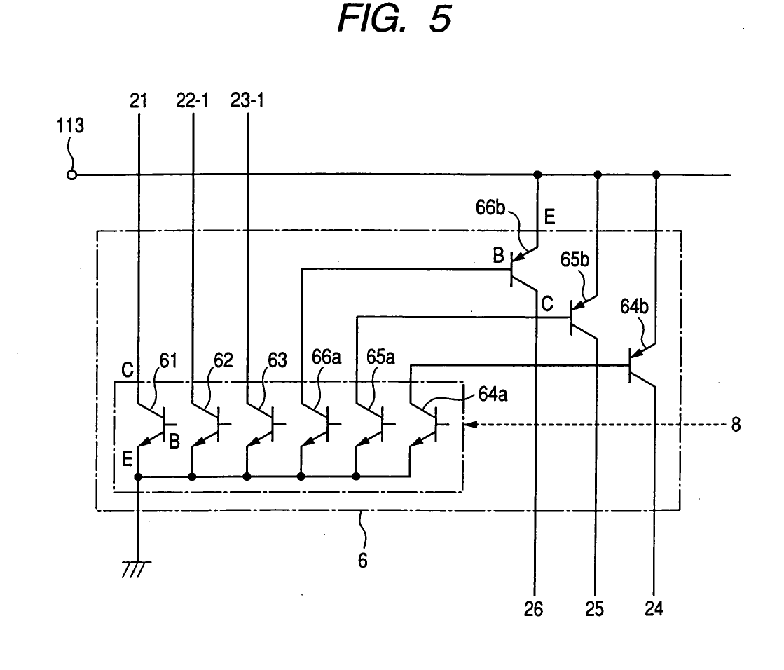

FIG. 5 is an enlarged view of an area in which the MOSFET drive section 6 is arranged. As illustrated in FIG. 5, the MOSFET drive section 6 is composed of nine bipolar transistors 61 to 63, 64a, 64b, 65a, 65b, 66a, and 66b. The bipolar transistors 61 to 63 and 64a to 66a are NPN transistors, and the remaining bipolar transistors 64b to 66b are PNP transistors.

The emitter of each of the bipolar transistors 61 to 63, 64a, 64b, 65a, 65b, 66a, and 66b is connected to the ground (signal common). The base of each of the bipolar transistors 61 to 63, 64a, 64b, 65a, 65b, 66a, and 66b is connected to the processor 8 such that the processor 8 is operative to individual drive the bipolar transistors 61 to 63, 64a, 64b, 65a, 65b, 66a, and 66b. The collector of the bipolar resistor 61 is connected to the gate of each of the P-channel MOSFETs 21a and 21b through the first voltage-driving resistor 51.

Similarly, the collector of the bipolar transistor 62 is connected to the gate of each of the P-channel MOSFETs 22-1a and 22-1b through the second voltage-driving resistor 52, and the collector of the bipolar transistor 63 is connected to the gate of each of the P-channel MOSFETs 23-1a and 23-1b through the third voltage-driving resistor 53.

The collector of the bipolar transistor 64a is connected to the base of the bipolar transistor 64b. Similarly, the collectors of the bipolar transistors 65a and 66a are connected to the bases of the bipolar transistors 65b and 66b, respectively.

The emitter of each of the bipolar transistors 64b to 66b is connected to the second intermediate potential terminal 113. The collector of the bipolar transistor 64b is connected to the gate of each of the N-channel MOSFETs 24a and 24b through the fourth voltage-dividing resistor 54. Similarly, the collector of the bipolar transistor 65b is connected to the gate of ech of the N-channel MOSFETs 25a and 25b through the fifth voltage-dividing resistor 55, and the collector of the bipolar transistor 66b is connected to the gate of each of the N-channel MOSFETs 26a and 26b through the sixth voltage-dividing resistor 56.

Operations of the voltage detection apparatus 10B will be described hereinafter.

As an example, when the processor 8 applies a voltage to the base B of the bipolar transistor 61, the collector emitter path of the bipolar transistor 61 is brought into conduction, in other words, the bipolar transistor 61 is turned on. This allows a current to flow in the order of the highest potential terminal 111, the intrinsic diode 210a of the MOSFET 21a, the first discharging resistor 31, the first voltage-dividing resistor 51, and the bipolar transistor 61.

The current through the first discharge resistor 31 causes a voltage drop of the gate G of each of the P-channel MOSFETs 21a and 21b, thereby decreasing the potential of the gate G of each of the P-channel MOSFETs 21a and 21b with respect to the potential of the source S thereof. This allows each of the P-channel MOSFETs 21a and 21b to turn on, bringing the drain-source path of the MOSFET 21a and the source-drain path of the MOSFET 21b into conduction.

This results in that the potential at the highest potential terminal 111 is applied to the first input terminal 71 of the voltage detection circuit 7.

Similarly, when the bipolar transistor 62 is turned on based on a voltage applied to its base from the processor 8, a current flows in the order of the first potential terminal 112, the intrinsic diode of the MOSFET 22-1a, the second discharging resistor 32, the second voltage-dividing resistor 52, and the bipolar transistor 62. Based on the current through the second discharge resistor 32, each of the P-channel MOSFETs 22-1a and 22-1b are turned on so that the potential at the first potential terminal 112 is applied to the second input terminal 72 of the voltage detection circuit 7.

When the bipolar transistor 63 is tuned on based on a voltage applied to its base from the processor 8, a current flows in the order of the second potential terminal 113, the intrinsic diode of the MOSFET 23-1a, the third discharging resistor 33, the third voltage-dividing resistor 53, and the bipolar transistor 63. Based on the current through the third discharge resistor 33, the P-channel MOSFETs 23-1a and 23-1b are turned on so that the potential at the second potential terminal 113 is applied to the first input terminal 71 of the voltage detection circuit 7.

As another example, when the processor 8 applies a voltage to the base of the bipolar transistor 66a, the collector-emitter path of the bipolar transistor 66a is brought into conduction, in other words, the bipolar transistor 66a is turned on. This allows a voltage to be applied to the base B of the bipolar transistor 66b, bringing the collector-emitter path of the bipolar transistor 66b into conduction. That is, the bipolar transistor 66b is turned on. This allows a current to flow in the order of the second intermediate potential terminal 113, the bipolar transistor 66b, the sixth voltage-dividing resistor 56, the sir discharging resistor 36, the intrinsic diode of the MOSFET 26a, and the lowest potential terminal 116.

The current through the sib discharge resistor 36 causes a voltage drop of the source of each of the N-channel MOSFETs 26a and 26b, thereby making the potential of the gate of each of the N-channel MOSFETs 26a and 26b higher than the potential of the source thereof. This permits each of the N-channel MOSFETs 26a and 26b to turn on, bringing the drain-source path of the MOSFET 26a and the source-drain path of the MOSFET 26b into conduction.

This results in that the potential at the lowest intermediate potential terminal 116 is applied to the second input terminal 72 of the voltage detection circuit 7.

Similarly when the bipolar transistor 65a is turned on based on a voltage applied to its base from the processor 8, the bipolar transistor 65b is subsequently turned on. The ON-state of the bipolar transistor 65b causes a current to flow in the order of the second intermediate potential terminal 113, the bipolar transistor 65b, the fifth voltage-dividing resistor 55, the fifth discharging resistor 35, the intrinsic diode of the MOSFET 25a, and the fourth intermediate potential terminal 115. Based on the current through the fifth discharging resistor 35, the N-channel MOSFETs 25a and 25b are turned on so that the potential at the fourth intermediate potential terminal 115 is applied to the first input terminal 71 of the voltage detection circuit 7.

When the bipolar transistor 64a is turned on based on a voltage applied to its base from the processor 8, the bipolar transistor 64b is subsequently turned on. The ON-state of the bipolar transistor 64b causes a current to flow in the order of the second intermediate potential terminal 113, the bipolar transistor 64b, the fourth voltage-dividing resistor 54, the fourth discharging resistor 34, the intrinsic diode of the MOSFET 24a, and the third intermediate potential terminal 114. Based on the current through the fourth discharging resistor 34, the N-channel MOSFETs 24a and 24b are turned on so that the potential at the third intermediate potential terminal 114 is applied to the second input terminal 72 of the voltage detection circuit 7.

Like the voltage detection circuit 7 of the apparatus 10 according to the first embodiment, the voltage detection circuit 7 of the apparatus 10B can measure voltages of the battery blocks 11 to 15 based on the potentials of tire potential terminals 111 to 116.

As set fourth above, the voltage detection apparatus 10B according to the third embodiment has substantially the same effects as the voltage detection apparatus 10 according to the first embodiment.

In addition, because the voltage detection apparatus 10B uses the bipolar transistors for driving the gate of each of the MOSFETs 21, 22-1, 23-1, 24, 25, and 26, it is possible to easily integrate the voltage detection apparatus 10B. In addition, use of the bipolar transistors for driving the gate of each of the MOSFETs 21, 22-1, 23-1, 24, 25, and 26 allows the MOSFET drive section 6 to be compact, making it possible to easily downsize the voltage detection apparatus 10B.

### Fourth Embodiment

A difference point between the structure of a battery-pack voltage detection apparatus 10C according to a fourth embodiment of the present invention and that of the battery-pack voltage detection apparatus 10 is that two pairs of P-channel MOSFETs are disposed in the voltage detection apparatus 10C in place of the second and fourth N-channel MOSFETs 23 and 25. Specifically, three pairs of the P-channel MOSFET and three pairs of N-channel MOSFETs are alternately arranged along the series direction of the battery pack 1.

Other remaining elements of the voltage detection apparatus 10C are substantially identical with those of the voltage detection apparatus 10 according to the first embodiment. To the remaining elements of the voltage detection apparatus 10C and the corresponding elements of the voltage detection apparatus 10 therefore, the same reference characters are assigned. The difference point therefore will be mainly described hereinafter.

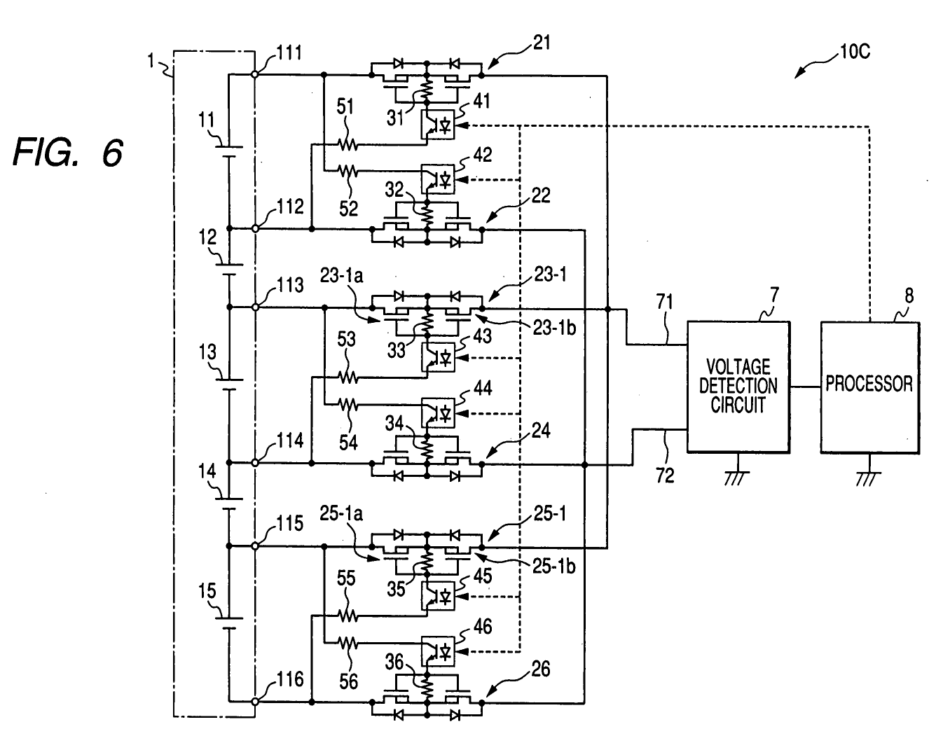

FIG. 6 illustrates an example of the circuit diagram of the voltage detection apparatus 10C according to the fourth embodiment. The structures of the P-channel MOSFETs 23-1 (23-1a, 23-1b) have been already described in the third embodiment of the present invention (see FIG. 4). In the fourth embodiment, like the first embodiment, the third photocoupler 43 is arranged between the third voltage-dividing resistor 53 and the third discharging resistor 33.

In addition, the P-channel MOSFETs 25-1 (25-1a, 25-1b) are configured to control open/close of the line between the fourth intermediate potential terminal 115 and the first input terminal 71 of the voltage detection circuit 7.

The drain of the P-channel MOSFET 25-1a is connected to the fourth intermediate potential terminal 115. The P-channel MOSFET 25-1a has an intrinsic diode between the drain and the source thereof like the intrinsic diode 210a of the P-channel MOSFET 21a.

The drain of the P-channel MOSFET 25-1b is connected to the first input terminal 71 of the voltage detection circuit 7. The P-channel MOSFET 25-1b has an intrinsic diode between the drain and the source thereof like the intrinsic diode 210b of the P-channel MOSFET 21b.

One end of the fifth discharging resistor 35 is connected to the common source of each of the P-channel MOSFETs 25-1a and 25-1b. The other end of the fifth discharging resistor 35 is connected to both the gate of the P-channel MOSFET 25-1a and that of the P-channel MOSFET 25-1b. The fifth photocoupler 45 is arranged between the fifth voltage-dividing resistor 55 and the fifth discharging resistor 35.

The voltage detection apparatus 10C according to the fourth embodiment is configured to operate like the apparatus 10 according to the first embodiment

For example, when measuring the potential at the highest potential terminal 111, the processor 8 controls to turn on the photocoupler 41. The ON-state of the photocoupler 41 allows a current to flow between the highest potential terminal 111 and the first intermediate potential terminal 112 in the order of the highest potential terminal 111, the intrinsic diode 210a, the first discharging resistor 31, the phototransistor 41b, the first voltage dividing resistor 51, and the first intermediate potential terminal 112. The current through the first discharge resistor 31 causes a voltage drop of the gate G of each of the P-channel MOSFETs 21a and 21b, thereby decreasing the potential of the gate G of each of the P-channel MOSFETs 21a and 21b with respect to the potential of the source S thereof. This allows each of the P-channel MOSFETs 21a and 21b to turn on, applying the potential at the highest potential terminal 111 to the first input terminal 71 of the voltage detection it 7. The potentials at the second intermediate potential terminal 113 and the fourth intermediate potential terminal 115 are measured like the potential at the highest potential terminal 111.

When measuring the potential at the first intermediate potential terminal 112, the processor 8 controls to switch the photocoupler 42 on. The ON-state of the photocoupler 42 permits a current to flow between the highest potential terminal 111 and the first intermediate potential terminal 112 in the order of the highest potential terminal 111, the second voltage-dividing resistor 52, the phototransistor 42b, the second discharging resistor 32, the intrinsic diode 220a, and the first intermediate potential terminal 112. The current through the second discharge resistor 32 causes each of the first N-channel MOSFETs 22a and 22b to turn on, allowing the potential at the first intermediate potential terminal 112 to be applied to the second input terminal 72 of the voltage detection circuit 7. The potentials at the third intermediate potential terminal 114 and the lowest potential terminal 116 are measured like the potential at the first intermediate potential terminal 112.

As described above, the voltage detection apparatus 10C according to the fourth embodiment substantially has the same effects as the voltage detection apparatus 10 according to the first embodiment.

Battery-pack voltage detection apparatuses according to the present invention are not limited to the structures of the voltage detection apparatuses according to the first to fourth embodiments set forth above, but can be modified and/or improved by persons skilled in the art.

For example, the voltage detection circuit 7 can be designed to a flying-capacitor type voltage detection circuit. The flying-capacitor type voltage detection circuit has the first and second input terminals 71 and 72, a capacitor, an analog switch, a differential amplifying circuit, and an A/D converter. The potentials input to the first and second input terminals 71 and 72 are charged in the electrodes of the capacitor, and the charged voltages are input to the differential amplifying circuit through the analog switch. A voltage output from the differential amplifying circuit is converted into digital data by the A/D converter.

In each of the first to fourth embodiments, the drains of the MOSFETs 21b, 23b, and 25b are connected to the first input t 71 of the voltage detection circuit 7 in the multiplex connection, and the drains of the MOSFETs 22b, 24b, and 26b are connected to the second input terminal 72 thereof in the multiplex connection. The drains of the MOSFET 21 to 23 and those of the MOSFETs 24 to 26 can be connected to the first input terminal 71 and the second input terminal 72 of the voltage detection circuit 7, respectively, in a mirror.

In addition, the first to sixth photocouplers 41 to 46 are used to drive the MOSFETs 21 to 26 with electrical-isolation between the battery pack 1 and the voltage detection circuit 7, but the present invention is not limited to the structure.

Specifically, other switching elements with electrical-isolation, such as photoMOS relays, can be used to drive the MOSFETs 21 to 26 with electrical-isolation between the battery pack 1 and the voltage detection circuit 7.

In place of the P-channel MOSFETs 21, 22-1, 23-1, and 251, switching elements each having at least three continuous semiconductor regions with alternating conductive type, such as PNP bipolar transistors, and flywheel diodes can be used. In addition, switching elements each having at least three continuous semiconductor regions with alternating conductive type, such as NPN bipolar transistors, and flywheel diodes can be used in place of the N-channel MOSFETs 22 to 26.

Moreover, in each of the first to fourth embodiments, five battery blocks 11 to 15 constitute the battery pack 1, but another number of battery blocks can constitute the battery pack 1.

### Fifth Embodiment

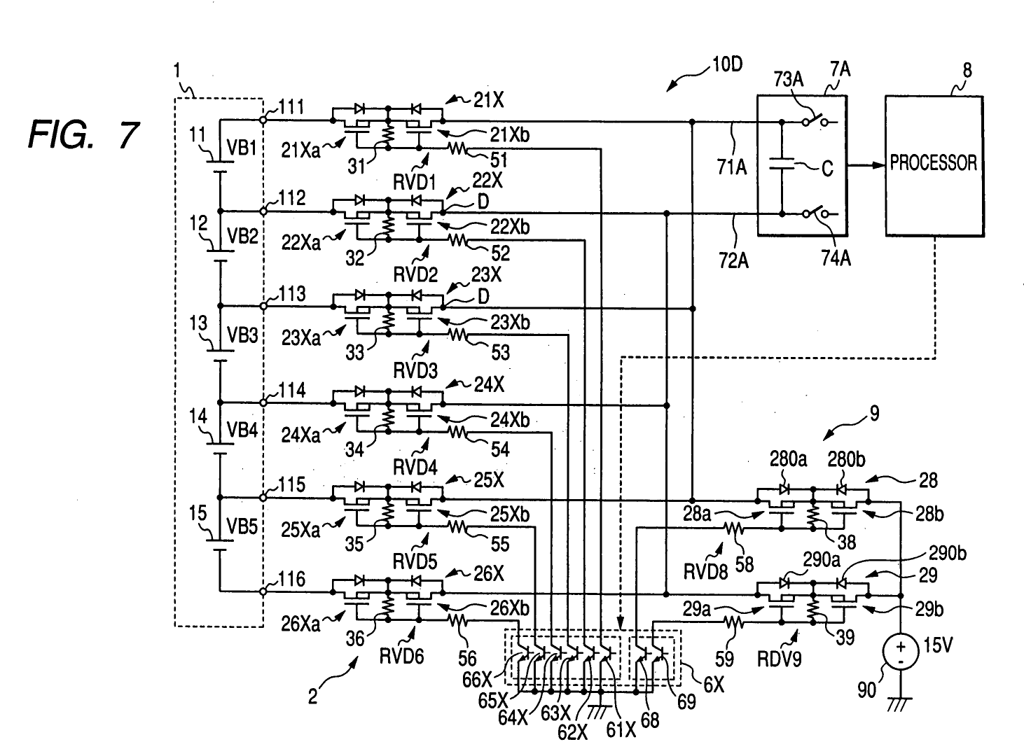

A battery-pack voltage detection apparatus according to a fifth embodiment of the present invention will be described hereinafter with reference to FIG. 7. To elements of the voltage detection apparatus according to the fun embodiment, which substantially correspond to those of the voltage detection apparatus according to any one of the fist to fourth embodiments, the same reference characters are assigned.

### Structure of the Apparatus

The voltage detection apparatus 10D according to the fifth embodiment of the present invention is provided with a multiplexer 2, and the multiplexer 2 is composed of first to sixth P-channel MOSFETs 21X to 26X as transfer switches, each of which has substantially the same structure as the P-channel MOSFET 21 according to the first embodiment.

Specifically, each of the first to six P-channel MOSFETs 21X (21Xa, 21Xb) to 26X (26Xa, 26Xb) is configured to control open/close of each of the lines between each of the potential terminals 111 to 116 and a voltage detection circuit 7A.

The drain of each of the P-channel MOSFETs 21Xa to 26Xa is connected to each of the potential terminals 111 to 116. Each of the P-channel MOSFET 21Xa to 26Xa has an intrinsic diode between the drain and the source thereof like the intrinsic diode 210a of the P-channel MOSS 21a.

The drain of each of the P-channel MOSFETs 21Xb, 23Xb, and 25Xb is connected to a first input terminal 71A of the voltage detection circuit 7A, and the drain of each of the P-channel MOSFETs 22Xb, 24Xb, and 26Xb is connected to a second input terminal (low-side input terminal) 72A of the voltage detection circuit 7A. Each of the P-channel MOSFETs 21Xb to 26Xb has an intrinsic diode between the drain and the source thereof like the intrinsic diode 210b of the P-channel MOSFET 21b.

One end of each of the first to so discharging resistors 31 to 36 is connected to each of the common sources of each of the P-channel MOSFETs 21X (21Xa, 21Xb) to 26X (26Xa, 26Xb). The other end of each of the first to sixth discharging resistors 31 to 36 is connected to the gates of each of the P-channel MOSFETs 21X (21Xa, 21Xb) to 26X (26Xa, 26Xb). Each of the first to sixth voltage-dividing resistors 51 to 56 has one end (low-potential end) and the other end (high-potential end). The high-potential end of each of the first to sixth voltage-dividing resistors 51 to 56 is connected to the other end of each of the first to sixth discharging resistors 31 to 36.

In addition, the voltage detection apparatus 10D is provided with a transistor array 6X composed of open collector, common emitter NPN bipolar transistors 61X to 66X, 68, and 69. Ech of the transistors 61X to 66X is operative to turn on/off each of the MOSFETs 21 to 26; these functions of the transistors 61X to 66X will be described hereinafter. The collector of each of the transistors 61X to 66X is connected to the paired gates of each of the MOSFETs 21X to 26X through each of the first to sixth voltage-dividing resistors 51 to 56. The base of ah of the transistors 61X to 66X is connected to the processor 8 such that the processor 8 is operative to individually drive the transistors 61X to 66X.

The paired gates of each of the MOSFETs 21X to 26X are connected to each common-source of each of the MOSFETs 21X to 26X through each of the first to six discharging resistors 31 to 36.

The pair of first discharging resistor 31 and the first voltage-dividing resistor 51 to the pair of sixth discharging resistor 36 and the sixth voltage-dividing resistor 56 constitute resistor voltage-dividing circuits RVD1 to RVD6, respectively. Power is fed to each of the resistor voltage-dividing circuits RVD1 to RVD6 from each of the potential terminals 111 to 116 through each of the intrinsic diodes of each of the MOSFETs 21Xa to 26Xa. The low-potential ends of the first to sixth voltage-dividing resistors 51 to 56 are connected to the collectors of the transistors 61X to 66X so that they are individually connected to the ground (signal common) through the transistors 61X to 66X, respectively.

The voltage detection circuit 7A is provided with, for example, a flying-capacitor circuit composed of a flying-capacitor C as a first amplifier stage, a pair of first and second transfer switches (analog switches) 73A and 74A, a differential amplifying circuit as a second amplifier stage, and an A/D converter connected to the differential amplifying circuit.

One of electrodes of the flying-capacitor C is connected to the fist input terminal 71A, and the other thereof is connected to the second input terminal 72A The first input terminal 71A is connected to the differential amplifying circuit through the first transfer switch 73A, and the second input t 72A is connected to the differential amplifying circuit through the second transfer switch 74A.

A voltage across the flying-capacitor C is fed to the differential amplifying circuit through the first and second transfer switches 73A and 74A to be amplified thereby. The amplified output voltage is converted into digital data by the A/D converter. The digital data corresponding to the output voltage of the flying-capacitor circuit is processed by the processor 8.

In addition, the voltage detection apparatus 10D is provided with a reference voltage applying circuit 9 for fixing either the potential at the first input terminal 71A of the voltage detection circuit 7A or that at the second input terminal 72A thereof.

Specifically, the reference voltage applying circuit 9 is provided with a constant voltage source 90 with one and the other output terminals, which produces a substantially constant reference voltage, such as 15 V. The one output terminal (negative output terminal) is connected to the ground (signal common). The reference voltage applying circuit 9 is also provided with a first pair of P-channel MOSFETs 28 (28a, 28b) and a second pair of P-channel MOSFETs 29 (29a, 29b).

The pair of MOSFETs 28 is configured to connect the other output terminal (positive output terminal) of the reference voltage applying source 90 to each of the lines between the first input terminal 71A and the drains of the MOSFETs 21Xb, 23Xb, and 25Xb.

The pair of MOSFETs 29 is configured to connect the positive output terminal of the reference voltage applying source 90 to each of the lines between the second input terminal 72A and the drains of the MOSFETs 22Xb, 24Xb, and 26Xb.

Like each of the MOSFETs 21X to 26X, the P-channel MOSFETs 28a and 28b have a common source, and the drain of the P-channel MOSFET 28a is connected to each of the lines between the first input terminal 71A and the drain of each of the MOSFETs 21Xb, 23Xb, and 25Xb. The MOSFET 28a has an intrinsic diode 280a between the drain and the source thereof like the intrinsic diode 210a of the P-channel MOSFET 21a.

In addition, the drain of the P-channel MOSFET 28b is connected to the positive output terminal of the constant voltage source 90, and the P-channel MOSFET 28b has an intrinsic diode 280b between the drain and the source thereof like the intrinsic diode 210b of the P-channel MOSFET 21b.

Similarly, the P-channel MOSFETs 29a and 29b have a common source, and the drain of the P-channel MOSFETs 29a is connected to each of the lines between the second input terminal 72A and the drain of each of the MOSFETs 22Xb, 24Xb, and 26Xb. The MOSFET 29a has an intrinsic diode 290a between the drain and the source thereof like the intrinsic diode 210a of the P-channel MOSFET 21a.

In addition, the drain of the P-channel MOSFET 29b is connected to the positive output terminal of the constant voltage source 90, and the P-channel MOSFET 29b has an intrinsic diode 290b between the drain and the source thereof like the intrinsic diode 210b of the P-channel MOSFET 21b.

The common source of the MOSFETs 28 is connected to the gates thereof through a discharging resistor 38, and connected to the collector of the transistor 68 through a voltage dividing resistor 58. Similarly, the common source of the MOSFETs 29 is connected to the gates thereof through a discharging resistor 39, and connected to the collector of the transistor 68 through a voltage dividing resistor 59.

The pair of discharging resistor 38 and the voltage-dividing resistor 58 constitutes a resistor voltage-dividing circuit RVD8. Power is fed to the resistor voltage-dividing circuit RVD8 from the constant voltage source 90, and the resistor voltage-dividing circuit RVD8 is connected to the ground (signal common) through the transistor 68.

Similarly, the pair of discharging resistor 39 and the voltage-dividing resistor 59 constitutes a resistor voltage-dividing circuit RVD9. Power is fed to the resistor voltage-dividing circuit RVD9 from the constant voltage source 90, and the resistor voltage-dividing circuit RVD9 is connected to the ground (signal common) through the transistor 69.

### Operations of the Voltage Detection Apparatus

Next, operations of the voltage detection apparatus 10D will be described hereinafter. Please note that no potential terminals 111 to 116 are connected to the grounded.

### Initial State

In an initial state of the voltage detection apparatus 10D, the transistors 61X to 66X of the transistor array 6 for tuning on/off the MOSFETs 21X to 26X are in OFF-state, and the transistors 68 and 69 for turning on/off the MOSFETs 28 and 29 are in OFF-state. The OFF-state of each of the transistors 61X to 66X, 68 and 69 will be further described.

The intrinsic diode of each of the MOSFETs 21Xa to 26Xa allows a current to flow therethrough based on each of the battery blocks 11 to 15 so that the potential at the common source of each of the MOSFETs 21X to 26X is lower than the voltage of the positive terminal of each of the battery blocks 11 to 15 by the voltage drop across each intrinsic diode.

Because the transistors 61X to 66X are in OFF-state, no current flows through the first to sixth discharging resistors 31 to 36 in the MOSFETs 21Xb to 26Xb so that the voltage difference between the common source (charge-carrier emission electrode) and the gate of each of the MOSFETs 21Xb to 26Xb has zero V. This causes the MOSFETs 21Xb to 26Xb to be in OFF-state.

The intrinsic diodes 280b and 290b of the MOSFETs 28b and 29b allow a current to flow therethrough based on the reference voltage output from the constant voltage source 90. This causes the potential at the common source of each of the MOSFETs 28 and 29 to be lower than the reference voltage output from the constant voltage source 90 by the voltage drop across each of the intrinsic diodes 280b and 290b.

Because the transistors 68 and 69 are in OFF-state, no current flows through the discharge resistors 38 and 39 in the MOSFETs 28a and 29a so that the voltage difference between the common source (charge-carrier emission electrode) and the gate of each of the MOSFETs 28a and 29a has zero V. This causes the MOSFETs 28a and 29a to be in OFF-state.

### Battery-Block Voltage Readout Operations

Next operations of readout voltages of the first to fifth battery blocks 11 to 15 to the voltage detection circuit 7A will be described hereinafter. In the fifth embodiment, for example, the voltages of the first, third, and fifth battery blocks 11, 13, and 15 are sequentially readout, and thereafter, the voltages of the second and fours battery blocks 12 and 14 are sequentially readout.

Before reading out any one of the voltages of the fist, third, and fifth battery blocks 11, 13, and 15, the MOSFET 29 is turned on so that the potential at the second input terminal 72A of the flying-capacitor C is fixed to the reference voltage of, for example, 15 V. Similarly, before reading out any one of the voltages of the second and fourth battery blocks 12 and 14, the MOSFET 28 is tuned on so that the potential at the first input terminal 71A of the sing-capacitor C is fixed to the reference voltage of 15 V.

When reading out a voltage of any one of the battery blocks 11 to 15 as a target battery block, a pair of transistors in the transistors 61X to 66X is selectively turned on. The paired transistors selectively tuned on are required to turn on a corresponding one of the MOSFETs 21X to 26X, which is connected to one of the potentials 111 to 116; this one of the potentials 111 to 116 is connected to the target battery block.

When the corresponding one of the MOSFETs 21X to 26X is tuned on based on the turning-on of the paired transistors, the voltage of the target battery block is applied to the flying-capacitor C, thereby charging the flying-capacitor C. After the flying-capacitor C has sufficiently charged, the selected pairs of transistors in the transistors 61X to 66X are turned off, and thereafter, the first and second transfer switches 73A and 74A are turned off, allowing a voltage across the flying-capacitor C based on the charges stored therein to be read out to the differential amplifying circuit. Thereafter, the first and second transfer switches 73A and 74A are turned off, proceeding voltage readout operations for another one of the battery blocks 11 to 15.

Specifically, one of the characteristics of the fifth embodiment is that the MOSFET 28 or 29 is turned on with any pair of the MOSFETs 21X to 26X being in ON state.

This characteristic allows the potential at the drain of any pair of MOSFETs 21X to 26X to be fixed to the reference voltage of 15 V when applying, to the gate of any pair of the MOSFETs 21X to 26X, an output voltage of a corresponding one of the resistor voltage-dividing circuit RVD1 to RVD6. Operations and effects obtained by relaxing the characteristic set forth above will be described hereinafter in detail further as an example of reading out a voltage VB1 of the first battery block 11.

### First Battery Block Voltage Readout Operations

When the transistor 69 is turned on by the processor 8, ON-state of the transistor 69 allows a current to flow through a circuit consisting of the ground, the constant voltage source 90, the intrinsic diode 290b of the MOSFET 29b, the disc ng resistor 39, the voltage-dividing resistor 59, the transistor 69, and the ground. This causes the potential at the gate of each of the MOSFETs 29a and 29b to be fixed, allowing the MOSFET 29b to be turned on. Fixing of the potential at the gate of each of the MOSFETs 29a and 29b permits an on-voltage to be applied between the common source (charge-carrier emission electrode) and the gate of the MOSFET, 29a, causing the MOSFET 29a to be turned on. The ON state of each of the MOSFETs 29a and 29b permits the potential at the drain D of the MOSFET 22Xb to be fixed to the reference voltage of 15 V.

Thereafter, when the transistor 62X is turned on by the processor 8, ON-state of the transistor 62X allows a current to flow through a circuit; his circuit consists of the ground, the constant voltage source 90, the MOSFETs 29a and 29b, the intrinsic diode of the MOSFET 22Xb, the second discharging resistor 32, the second voltage-dividing resistor 52, the transistor 62, and the ground. The current flowing through the second discharging resistor 32 causes a voltage drop across the second discharging resistor 32, resulting in that the potential at the gate of each of the MOSFETs 22Xa and 22Xb decreases. This permits the MOSFET 22Xb to be turned on. In addition, because the potential at the common source of each of the MOSFETs 22Xa and 22Xb to be lower than the reference voltage at the drain thereof by the voltage drop across the intrinsic diode 22Yb, the constant voltage drop across the second discharging resistor 32 is applied to the common source-gate region of the MOSFET 22Xa. This allows the MOSFET 22Xa to be turned on with a low ON resistance.

When the transistor 61X is turned on by the processor 8, ON-state of the transistor 61X allows a current to flow through a circuit; this circuit consists of the ground, the constant voltage source 90, the MOSFETs 29a and 29b, the MOSFETs 22Xa and 22Xb, the first voltage block 11, the intrinsic diode of the MOSFET 21Xa, the first discharging resistor 31, the first voltage-dividing resistor 51, the transistor 61X, and the ground. The current flowing through the first resistor 31 causes a constant voltage drop across the first discharging resistor 31, resulting in that the potential at the gate of each of the MOSFETs 21Xa and 21Xb decreases. This permits the MOSFET 21Xb to be turned on. In addition, the constant voltage drop across the first discharging resistor 31 is applied to the common source-gate region of the MOSFET 21Xa. This allows the MOSSES 21Xa to be turned on with a low ON resistance. The ON state of each of the MOSFETs 21Xa and 21Xb permits the potential at the drain D of the MOSFET 21Xb to be fixed to the sum of the reference voltage of 15 V and the voltage of the first battery block 11.

That is, turning-on of each of the transistors 61X and 62X allows each of the MOSFETs 21X and 22X to be turned on. This enables a current to flow through a flying-capacitor charging circuit consisting of the first battery block 11, the highest potential terminal 111, the MOSFETs 21Xa and 21Xb, the flying-capacitor C, the MOSFETs 22Xa and 22Xb, and the first intermediate potential terminal 112. This permits the first battery block 11 to charge the flying-capacitor C.

Specifically, in the fifth embodiment of the present invention, because the constant reference voltage of 15 V causes the current (constant bias current) to flow through the second discharging resistor 32, a constant voltage drop across the second discharging resistor 32 is generated. The constant voltage drop across the second discharging resistor 32 allows each of the MOSFETs 22Xa and 22Xb to be turned on with a low ON resistance

Similarly, as set forth above, because the constant reference voltage of 15 V and the voltage of the first battery block 11 cause the current (constant bias current) to flow through the first discharging resistor 31, a constant voltage drop across the first discharging resistor 31 is generated. The constant voltage drop across the first discharging resistor 31 allows each of the MOSFETs 21Xa and 21Xb to be turned on with a low ON resistance.

As described above, in the fifth embodiment of the present invention, each of the MOSFETs 21 and 22 is turned on by a low ON-resistance, making it possible to rapidly readout the voltage of the first battery block 11 to charge the readout voltage in the flying capacitor C.

Specifically, in the fifth embodiment, turning-on of the MOSFETs 29 allows the potential at the drain (charge carrier collection region) D of the MOSFET 22Xb to be securely fixed to the reference voltage of 15 V, which is higher than the potential at the gate thereof. This allows the channel resistance of the MOSFET 22Xb to greatly decrease, making it possible to have rapidly completed the charge of the flying-capacitor C.

In other words, in the fifth embodiment, adding, to the P-channel MOSFET 22Xb operating as a source follower, a constant bias current for maintaining the ON-resistance of the MOSFET 22Xb low makes it possible to keep the channel resistance of the MOSFET 22Xb low, allowing high-speed readout of the first battery blocks voltage.

The first battery-block voltage readout operations have been described set forth above, and readout operations for the remaining second to fifth battery-block voltages therefore can be performed like the first battery-block voltage readout operations.

For example, in order to readout a voltage VB2 of the second battery block 12, turning-on of the transistor 68 allows the MOSFET 28 to be turned on, resulting in that the drain D of the MOSFET 23Xb is fixed to the reference voltage of 15 V.

Thereafter, when the transistor 63X is turned on, the MOSFETs 23 are turned on. When the transistor 62X is turned on, ON-state of the transistor 62X allows a current to flow through a circuit; this circuit consists of the ground, the constant voltage source 90, the MOSFETs 28a and 28b, the MOSFETs 23Xa and 23Xb, the second voltage block 12, the intrinsic diode of the MOSFET 22Xa, the second discharging resistor 32, the second voltage-dividing resistor 52, the transistor 62X, and the ground. The current flowing through the second discharging resistor 32 causes a constant voltage drop across the second discharging resistor 32, resulting in that the potential at the gate of each of the MOSFETs 22Xa and 22Xb decreases. This permits the MOSFET 22Xa and 22Xb to be turned on.

That is, the turning-on of the transistors 62X and 63X enables a current to flow through a flying-capacitor charging circuit consisting of the second battery block 12, the first intermediate potential terminal 112, the MOSFETs 22Xa and 22Xb, the flying-capacitor C, the MOSFETs 23Xa and 23Xb, and the second intermediate potential terminal 113. This permits the second battery block 12 to charge the flying-capacitor C.

Similarly, in order to readout a voltage VB3 of the third battery block 13, turning-on of the MOSFETs 29, the transistor 64X, and the transistor 63X allows a constant current to flow through a flying-capacitor charging circuit consisting of the third battery block 13, the second intermediate potential terminal 113, the MOSFETs 23Xa and 23Xb, the flying-capacitor C, the MOSFETs 24Xa and 24Xb, and the third intermediate potential terminal 114. This permits the third battery block 13 to charge the flying-capacitor C.

As set forth above, in the fifth embodiment, for reading out any one of the battery blocks 11 to 15 as a target battery block through the multiple 2 to the voltage detection circuit 7A, at least one pair of MOSFETs, which is required to readout the voltage of the target battery block, of the multiplexer 2 is turned on. Before at least one pair of MOSFETs is turned on, the reference voltage applying circuit 9 allows the potential at the drain (charge carrier collection region) of one of the paired MOSFETs, which substantia operates as a source follower, to be fixed to the reference voltage; his reference voltage permits the one of the paired MOSFETs to become sufficiently ON-state. This makes it possible to extremely speed up the battery-block voltage readout operations every battery block, as compared with performing battery-block voltage readout operations every battery block without using the reference voltage applying circuit.

Note that, when reading out the voltage of the first battery block 11 to the voltage detection circuit 7A, start of the voltage fixing operations by turning-on of the MOSFETs 29 can be performed before turning-on of the MOSFETs 21X and/or 22X, in parallel with turning-on of the MOSFETs 21X and/or 22X, or after turning-on of the MOSFETs 21X and/or 22X. In addition, note that stop of the voltage fixing operations by turning-off of the MOSFETs 29 can be performed before turning-off of the MOSFETs 21X and/or 22x, in parallel with turning-off of the MOSFETs 21X and/or 22X, or after turning-off of the MOSFETs 21X and/or 22X.

When tuning the MOSFETs 29 off after turning-off of the MOSFETs 21X and/or 22X, it is possible to reduce changes of wiring potentials due to electrostatic induction and/or electromagnetic induction; these changes of wiring potentials may have an influence on the charged potential of the flying-capacitor C at the moment of turning-off of the MOSFETs 21X and/or 22X. It is possible to, therefore, prevent electromagnetic noises and/or electrostatic noises from being overlapped on the readout voltages, and reducing thermal noises.

In the fifth embodiment, as each of the transfer switches of the multiplexer 2, a pair of P-channel MOSFETs whose sources are connected to each other is used, but one of the P-channel MOSFETs, which is disposed to the battery pack side, can be omitted. As each of the transfer switches of the multiplexer 2, a pair of N-channel MOSFETs whose sources are connected to each other can be used.

In the fifth embodiment, the emitter common transistor array EX is used to turn the MOSFETs 21X to 26X on, but other types of transistors which allow the gate of each of the MOSFETs 21X to 26X to be grounded through a resistor can be used in place of the emitter common transistor array 6X.

The discharging resistors 31 to 36 and the voltage-dividing resistors 51 to 56 constitute resistor voltage-dividing circuits RVD1 to RVD6 and have voltage drop functions, respectively. The discharging resistors 31 to 36 and the voltage-dividing resistors 51 to 56 therefore can be replaced to other voltage-drop elements or circuits except for resistors. For example, causing a constant current to flow through each of the transistors 61X to 66X permits the voltage-dividing resistors 51 to 56 to be omitted.

The voltage detection circuit 7A can use a differential voltage amplifying circuit with high direct current (DC) input-resistance without using the flying-capacitor circuit as the first amplifier stage.

### Sixth Embodiment

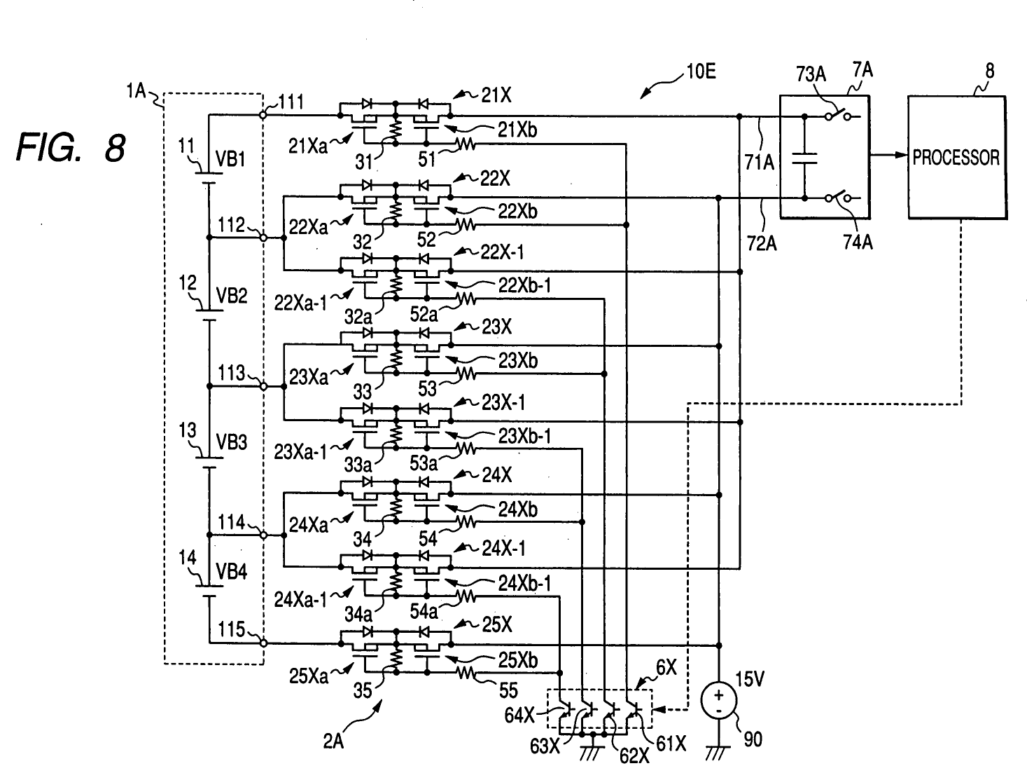

A battery-pack voltage detection apparatus according to a sixth embodiment of the present invention will be described hereinafter with reference to FIG. 8.

As illustrated in FIG. 8, a battery pack 1A is composed of the first to fourth battery blocks 11 to 14 connected to each other in series.

Compared to the structure of the apparatus 10D, the battery-pack voltage detection apparatus 10E does not use the MOSFETs 28 and 29 in the reference voltage applying circuit 9. Specially, the battery-pack voltage detection apparatus 10E is configured such that the positive output terminal of the constant voltage source 90 is directly connected to the second input terminal 72A of the voltage detection circuit 7A. That is, the lines between the second input terminal 72A and the drains of the MOSFETs 22Xb, 24Xb, and 26Xb are connected to the positive output terminal of the constant voltage source 90.

In addition, the multiplexer 2A of the apparatus 10E further includes P-channel MOSFETs 22X-1 (22Xa-1, 22Xb-1) to 22X-4 (22Xa-4, 22Xb-4), discharging resistors 32a to 34a, and voltage-dividing resistors 52a to 54a.

In the sixth embodiment, the MOSFET 21X is configured to control open/close of the line between the potential terminal 111 and the first input terminal 71A of the voltage detection circuit 7A. In addition, each of the MOSFETs 22X to 25X is configured to control open/close each of the lines between each of the potential terminals 112 to 115 and the second input terminal 72A of the voltage detection circuit 7A. Each of the MOSFETs 22X-1 to 22X-4 is configured to control open/close of each of the lines between the potential terminals 112 to 115 and the first input terminal 71A of the voltage detection circuit 7A.

One end of each of the discharging resistors 32a to 34a is connected to each of the common sources of each of the MOSFETs 22X-1 to 24X-1. The other end of each of the discharging resistors 32a to 34a is connected to the gates of each of the MOSFETs 22X-1 to 24X-1. A high-potential end of each of the voltage-dividing resistors 52a to 54a is connected to the other end of the discharging resistors 32a to 34a. The discharging resistors 32a to 34a and the voltage-dividing resistors 52a to 54a are operative to set the potential at the gate of each MOSFETs 22X-1 to 24X-1, which are substantially identical with the discharging resistors 31 to 36 and the voltage-dividing resistors 51 to 56.

The low-potential ends of the voltage-dividing resistors 51 and 52 corresponding to a first pair of MOSFETs 21X and 22X are connected to the collector of the transistor 61X, and the low-potential ends of the voltage dividing resistors 52a and 53 corresponding to a second pair of MOSFETs 22X-1 and 23X are connected to the collector of the transistor 62X. Similarly, the low-potential ends of the voltage-dividing resistors 53a and 54 corresponding to a third pair of MOSFETs 23X-1 and 24X are connected to the collector of the transistor 63X, and the low-potential ends of the voltage-dividing resistors 54a and 55 corresponding to a fourth pair of MOSFETs 24X-1 and 25X are connected to the collector of the transistor 64X.

The same reference characters are assigned to the other remaining elements of the voltage detection apparatus 10E and the corresponding elements of the voltage detection apparatus 10D so that descriptions of the other remaining elements of the voltage detection apparatus 10E are omitted.

Next, operations of readout voltages of the first to fourth battery blocks 11 to 14 to the voltage detection circuit 7A will be described hereinafter.

Because the reference voltage of 15V is applied to the drain of the MOSFET 22Xb, turning-on of the transistor 61X allows the MOSFETs 22X and 21X to be turned on, permitting the voltage of the first battery block 11 to be read out to the flying-capacitor C, which is a substantially similar manner to the fifth embodiment.

Similarly because the reference voltage of 15V is applied to the drain of the MOSFET 23Xb, turning-on of the transistor 62X allows the MOSFETs 23X and 22X-1 to be turned on, permitting the voltage of the second battery block 12 to be read out to the flying-capacitor C, which a substantially similar manner to the fifth embodiment.

Moreover, because the reference voltage of 15V is applied to the drain of the MOSFETs 24Xb, turning-on of the transistor 63X allows the MOSFETs 24X and 23X-1 to be turned on, permitting the voltage of the third battery block 13 to be read out to the flying-capacitor C, in a substantially similar manner to the fifth embodiment. Furthermore, because the reference voltage of 15V is applied to the drain of the MOSFET 25Xb, turning-on of the transistor 64X allows the MOSFETs 25X and 24X-1 to be turned on, permitting the voltage of the fourth battery block 14 to be read out to the flying-capacitor C, in a substantially similar manner to the fifth embodiment.

As described above, in the sixth embodiment of the present invention, when turning on one of first pair of MOSFETs 21X and 22X to the fourth pair of MOSFETs 24X-1 and 25 the potential at the drain (charge carrier collection region) of each of the MOSFETs 22Xb, 23Xb, and 24Xb, which operate as a source follower, is fixed to the constant reference voltage of 15 V. This allows the voltage detection apparatus 10E according to the sixth embodiment to have substantially the same effects as the voltage detection apparatus 10D according to the fit embodiment.

### Seventh Embodiment

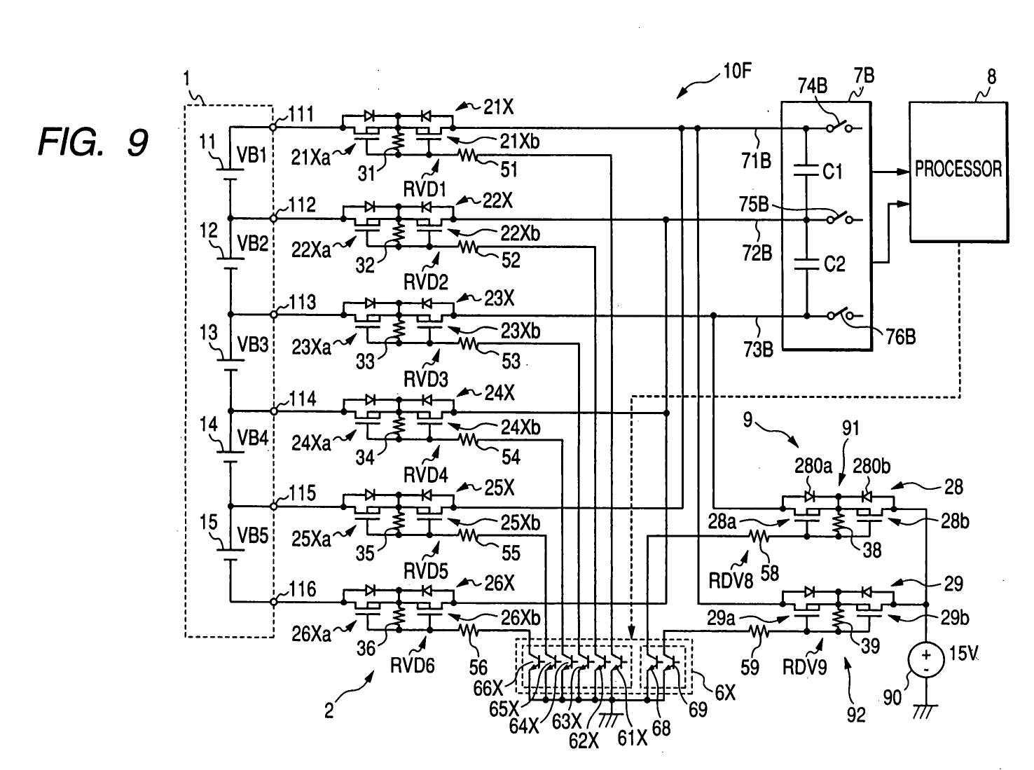

A battery-pack voltage detection apparatus according to a seventh embodiment of the present invention will be described hereinafter with reference to FIG. 9.

A voltage detection circuit 7B of the battery-pack voltage detection apparatus 10F is provided with a first flying-capacitor circuit with a first flying-capacitor C1, and a second flying-capacitor circuit C2 with a second flying-capacitor C2, which serve as a first amplifier stage. The voltage detection chit 7B is also provided with first to third input terminals 718, 72B, and 73B, first to third transfer switches (analog switches) 74B to 76B, a differential amplifying circuit as a second amplifier stage, and an A/D converter connected to the differential amplifier.

One of the electrodes of the first flying-capacitor C1 is connected to the first input terminal 71B, and the other thereof is connected to the second input terminal 72B. One of electrodes of the second flying-capacitor C2 is connected to the second input terminal 72B, and the other thereof is connected to the third input terminal 73B.

The first to third input terminals 71D to 73B are connected to the differential amplifying circuit through the first to third transfer switches 74B to 76B, respectively.

Each of the MOSFETs 21X and 21X is configured to control open/close of each of the lines between each of the potential terminals 111 and 115 and the first input terminal 71B of the voltage detection circuit 7B. Each of the MOSFETs 22X, 24X and 26X is configured to control open/close of each of the lines between each of the potential terminals 112, 114 and 116 and the second input terminal 72B of the voltage detection circuit 7. The MOSFETs 23X is configured to control open/close of the line between the potential terminal 113 and the third input terminal 73B of the voltage detection circuit 71.

In addition, in the seventh embodiment, the drain of the P-channel MOSFET 28a is connected to the line between the potential terminal 113 and the third switching terminal 73B. The drain of the P-channel MOSFET 29a is connected to the line between the potential ter 111 and the first switching terminal 73B.

The same reference characters are assigned to the other remaining elements of the voltage detection apparatus 10F and the corresponding elements of the voltage detection apparatus 10F so that descriptions of the other remaining elements of the voltage detection apparatus 10F are omitted.

When the MOSFETs 28 are turned on by turning the transistor 68 on, the potential at the drain of the MOSFET 23Xb to be fixed to the reference voltage of 15V.

Thereafter, when the transistor 63X is turned on, ON-state of the transistor 63X allows a current to flow through a circuit; this circuit consists of the ground, the constant voltage source 90, the MOSFETs 28a and 28b, the intrinsic diode of the MOSFET 23Xb, the third discharging resistor 33, the third voltage-dividing resistor 53, the transistor 63X, and the ground. The current flowing through the third discharging resistor 33 causes a constant voltage drop across the third discharging resistor 33, allowing the MOSFET 23Xa and 23Xb to be turned on with a low ON resistance.

Thereafter, when the transistor 61X is turned on, ON-state of the transistor 61X allows a current to flow through a circuit; this circuit consists of the ground, the constant voltage source 90, the MOSFETs 28a and 28b, the MOSFETs 23Xa and 23Xb, the second voltage block 12, the first voltage block 11, the intrinsic diode of the MOSFET 21Xa, the first discharging resistor 31, the first voltage-dividing resistor 51, the transistor 61X and the ground. The current flowing through the first dish resistor 31 causes a constant voltage drop across the first discharging resistor 31, allowing the MOSFET 21Xa and 21Xb to be turned on with a low ON resistance.

For example, simultaneously with the turning-on of the transistor 61X, when the transistor 62X is turned on, ON-state of the transistor 62X allows a current to flow through a circuit; this circuit consists of the ground, the constant voltage source 90, the MOSFETs 28a and 28b, the MOSFETs 23Xa and 23Xb, the second voltage block 12, the intrinsic diode of the MOSFET 22Xa, the second discharging resistor 32, the second voltage-dividing resistor 52, the transistor 62X, and the ground. The current flowing through the second discharging resistor 32 causes a constant voltage drop across the second discharging resistor 32, allowing the MOSFET 22Xa and 22Xb to be turned on with a low ON resistance.

The tuning-on of the MOSFETs 21V, 22X, and 23X allow the voltages of the first battery block 11 and the second battery block 12 to be simultaneously read out to the first and second flying-capacitors C1 and C2, respectively.

Similarly, when the MOSFETs 29 are turned on by turning the transistor 69 on, the potential at the drain of each of the MOSFETs 21Xb and 25Xb to be fixed to the reference voltage of 1V.

Thereafter, when the transistor 63X is turned on, ON-state of the transistor 63X allows a current to flow through a circuit; this circuit consists of the ground, the constant voltage source 90, the MOSFETs 29a and 29b, the MOSFETs 25Xa and 25Xb, the fourth voltage block 14, the td voltage block 13, the intrinsic diode of the MOSFET 23Xa, the third discharging resistor 33, the third voltage-dividing resistor 53, the transistor 63X, and the ground. The current flowing through the third discharging resistor 33 causes a constant voltage drop across the third discharging resistor 33, allowing the MOSFET 23Xa and 23Xb to be turned on with a low ON resistance.

For example, simultaneously with the turning-on of the transistor 63) when the transistor 64X is turned on, ON-state of the transistor 64X allows a current to flow through a circuit; this circuit consists of the ground, the constant voltage source 90, the MOSFETs 29a and 29b, the MOSFETs 25Xa and 25Xb, the fourth voltage block 14, the intrinsic diode of the MOSFET 24Xa, the fourth discharging resistor 34, the fourth voltage-dividing resistor 54, the transistor 64X, and the ground. The current flowing through the fourth discharging resistor 34 causes a constant voltage drop across the fourth discharging resistor 34, allowing the MOSFET 24Xa and 24Xb to be turned on with a low ON resistance.

The turning-on of the MOSFETs 23X, 24X, and 25X allow the voltages of the third battery block 13 and the fourth battery block 14 to be simultaneously read out to the first and second flying-capacitors C1 and C2, respectively.

The voltage of the fifth battery block 15 is read out to the first-flying capacitor C1 in a substantially similar manner to the fifth embodiment.

As described above, in the seventh embodiment, it is possible to simultaneously readout, to the flying-capacitors, voltages of a plurality of battery blocks whose number corresponds to the number of the flying-capacitors of the voltage detection circuit 7B. This makes it possible to further speed up voltages of all of the battery blocks.

### Eighth Embodiment

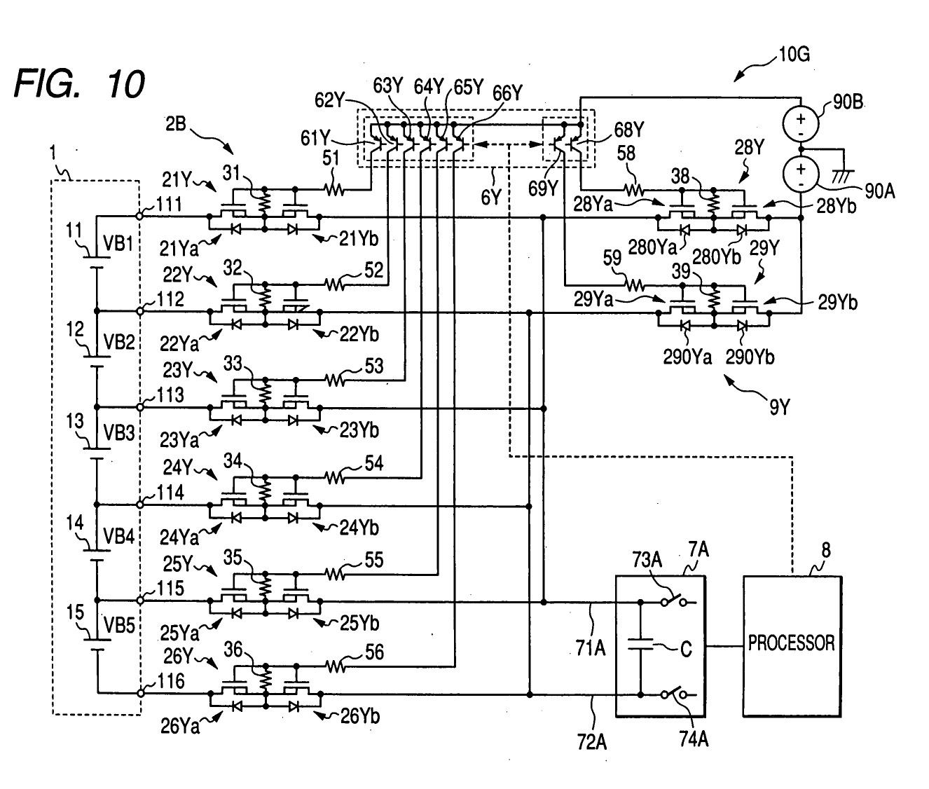

A battery-pack voltage detection apparatus according to an eighth embodiment of the present invention will be described hereinafter with reference to FIG. 10.

In the battery-pack voltage detection apparatus 10G, a multiplexer 2B is composed of first to sixth N-channel MOSFETs 21Y to 26Y as transfer switches, in place of the P-channel MOSFETs 21X to 26X according to the fifth embodiment. The structure of each of the N channel MOSFETs 21Y to 26Y is substantially identical with that of the N-channel MOSFET 22 according to the first embodiment. The description of the N-channel MOSFETs structure is therefore simplified.

Specifically, each of the first to sixth N-channel MOSFETs 21Y (21Ya, 21Yb) to 26Y (26Ya, 26Yb) is configured to control open/close of each of the lines between each of the potential terminals 111 to 116 and the voltage detection circuit 7A.

A voltage detection apparatus 10G is provided with a transistor array 6Y composed of common emitter PNP transistors 61Y to 66Y, 68Y, and 69Y in place of the NPN bipolar transistors 61X to 66X, 68, and 69 according to the fifth embodiment.

In addition, a reference voltage applying circuit 9Y is provided with a pair of constant voltage sources 90A and 90B each with one and the other output terminals, each of which produces a substantially constant reference voltage, such as 15 V. The one output terminal (positive output terminal) of the constant voltage source 90A and the one output to (negative output terminal) of the constant voltage source 90B are connected at a point, and the point is connected to the ground (signal common). The reference voltage applying circuit 9Y is also provided with a first pair of N-channel MOSFETs 28Y (28Ya, 28Yb) and a second pair of N-channel MOSFETs 29Y (29Ya, 29Yb) in place of the P-channel MOSFETs 28 and 29 according to the fifth embodiment.

The structure of each of the N-channel MOSFETs 28Y and 29Y is substantially identical with that of the N-channel MOSFETs 22 according to the first embodiment The description of the N-channel MOSFETs structure is therefore omitted or simplified.

Specifically, the pair of MOSFETs 28Y is configured to connect the other output terminal (negative output terminal) of the reference voltage applying source 90A to each of the lines between the first input terminal 71A and the drains of the N-channel MOSFETs 21Yb, 23Yb, and 25Yb.

The pair of MOSFETs 29Y is configured to connect the negative output terminal of the reference voltage applying source 90A to each of the lines between the second input terminal 72A and the drains of the N-channel MOSFETs 22Yb, 24Yb, and 26Yb.

Specifically, the drain of the N-channel MOSFET 28Ya is connected to each of the lines between the first input terminal 71A and the drain of each of the MOSFETs 21Yb, 23Yb, and 25Yb.

In addition, the drain of the N-channel MOSFET 28Yb is connected to the negative output terminal of the constant voltage source 90A, and the N-channel MOSFET 28Yb has an intrinsic diode 28Yb between the drain and the source thereof like the intrinsic diode 210b of the P-channel MOSFET 21b.

Similarly, the drain of the N channel MOSFET 29Ya is connected to each of the lines between the second input terminal 72A and the drain of each of the MOSFETs 22Yb, 24Yb, and 26Yb. The MOSFET 29Ya has an intrinsic diode 29Ya between the drain and the source thereof like the intrinsic diode 220a of the N-channel MOSFET 22a.

In addition, the drain of the N-channel MOSFET 29Yb is connected to the negative output-terminal of the constant voltage source 90A, and the N-channel MOSFET 29Yb has an intrinsic diode 290b between the drain and the source thereof like the intrinsic diode 220b of the N-channel MOSFET 22b.

The positive terminal of the constant voltage source 90B is connected to the common emitter of each of the PNP bipolar transistors 61Y to 6Y, 68Y, and 69Y. Note that the constant voltage source 90B can be omitted. The gate of each of the N-channel MOSFETs 21Y to 26Y, 28Y, and 29Y and that of each of the PNP bipolar transistors 61Y to 66Y, 68Y, and 69Y are connected to the processor 8.

In the eighth embodiment, in order to readout the voltage of the first battery block 11 as a target battery block, when the MOSFETs 28Y are turned on by turning the transistor 68Y on, the potential at the drain of the MOSFETs 21Yb is fixed to the reference voltage of −15 V.

Thereafter, when the transistor 61Y is turned on by the processor 8, ON-state of the transistor 61Y allows a current to flow through a circuit; this circuit consists of the ground, the constant voltage source 903, the transistor 61Y, the first voltage-dividing resistor 51, the first discharging resistor 31, the intrinsic diode of the MOSFET 21Yb, the MOSFETs 28Y, the constant voltage source 90A, and the ground.

The current flowing through the first discharging resistor 31 causes a voltage drop across the first discharging resistor 31, resulting in that the potential at the gate of each of the MOSFETs 21Ya and 21Yb increases. This permits the MOSFET 21Yb to be turned on. In addition, the constant voltage drop across the first discharging resistor 31 is applied to the region between the gate and the common-source of the MOSFET 21Ya. This allows the MOSFET 21Ya to be turned on with a low ON resistance.

When the transistor 62Y is turned on by the processor 8, ON-state of the transistor 62Y allows a current to flow through a circuit this circuit consists of the ground, the constant voltage source 90B, the transistor 62Y, the second voltage-dividing resistor 52, the second discharging resistor 32, the intrinsic diode of the MOSFET 22Ya, the fist battery block 11, the MOSFETs 21Y, the MOSFETs 28Y, the constant voltage source 90A, and the ground.

The current flowing through the second discharging resistor 32 causes a voltage drop across the second discharging resistor 32, resulting in that the potential at the gate of each of the MOSFETs 22Ya and 22Yb increases. This permits the MOSFET 22Yb to be tuned on. In addition, the constant voltage drop across the second discharging resistor 32 is applied to the region between the gate and the common-source of the MOSFET 22Ya. This allows the MOSFET 22Ya to be turned on with a low ON resistance.

The turning-on of the MOSFETs 21Y and 22Y allows the voltage of the battery block 11 to be read out to the flying-capacitor C of the voltage detection circuit 7A.

The voltages of the remaining second to fifth battery blocks 12 to 15 can be charged in the flying-capacitor C like the voltage of the first battery block 11.

For example, turning-on of the MOSFETs 29Y allows the voltage of the second battery block 12 to be charged in the flying-capacitor C.

As described above, in the eighth embodiment of the present invention, the constant reference voltage −15V at the drain of each of the N-channel MOSFETs 22Yb and 21Yb allows ON-resistance in the region between the common-source and gate thereof to decrease, making it possible to speed up the readout of the voltage of the first battery block 11. By the same reason as the first battery block 11, it is possible to speed up the readout of voltages of the second to fifth battery blocks 12 to 15. In addition, because the N-channel MOSFETs 21Y to 26Y have a comparatively low ON-resistance as compared with P-channel MOSFETs, it is possible to further speed up the readout of voltages of the first to fifth battery blocks 11 to 15.

Battery-pack voltage detection apparatuses according to the present invention are not limited to the structures of the voltage detection apparatuses according to the fifth to eighth embodiments set forth above, but can be modified and/or improved by persons skilled in the art.

In each of the fifth to eighth embodiments, five or four batter blocks constitute the battery pack, but another number of battery blocks can constitute the battery pack.

In each of the first to eighth embodiments, the battery-pack voltage detection apparatuses 10, and 10A to 10G are realized for hybrid vehicles, but battery-pack voltage detection apparatuses according to the present invention can be realized for electric vehicles, fuel-cell vehicles, or the like.

It is assumed that the number of the battery blocks is an even number and at least one switching element having NPN semiconductor region, such as N-channel transistor or NPN bipolar transistor, is used for controlling open/close of the line between the lowest potential terminal 116 and the input terminal 72 (72A, 72B) of the voltage detection circuit 7 (7A, 7B). In this assumption, another type switching element, such as a photoelectric switching element, can be used for controlling open/close of the line between the highest potential terminal 111 and the input terminal 71 (71A, 71B) of the voltage detection circuit 7 (7A, 7B).

It is assumed that the number of the battery blocks is an even number and at least one switching element having PNP semiconductor region, such as P-channel MOSFET or PNP bipolar transistor, is used for controlling open/close of the line between the highest potential terminal 111 and the input terminal 71 (71A, 71B) of the voltage detection circuit 7 (7A, 7B). In this assumption, another type switching element, such as a photoelectric switching element, can be used for controlling open/close of the line between the lowest potential terminal 116 and the input terminal 72 (72A, 72B) of the voltage detection circuit 7.

While there has been described what is at present considered to be these embodiments and modifications of the present invention, it will be understood that various modifications which are not described yet may be made therein, and it is intended to cover in the appended claims all such modifications as fall within the true spirit and scope of the invention.

What is claimed is:

1. A battery-pack voltage detection apparatus connected to a battery pack, the battery pack comprising N series connected battery modules, the N being an integer equal to or more than 2; and N+1 potential terminals corresponding to a highest potential, a lowest potential, and N−1 intermediate potentials of the N series battery modules, the battery-pack voltage detection apparatus comprising:
a voltage detection circuit connected to the N+1 potential terminals;
N+1 switches each having at least first, second, and third continuous semiconductor regions with alternating conductivity type, the N+1 switches being configured to individually open/close the connections of the N+1 potential term als and the voltage detection circuit; and
N+1 driving units connected to at least one of the N+1 potential terminals and configured to apply at least one potential at at least one of the N+1 potential terminals to each of the N+1 switches to drive each of the N+1 switches.

2. A battery-pack voltage detection apparatus according to claim 1, wherein the N+1 potential terminals include a highest potential terminal corresponding to the highest potential of the N series battery modules, a lowest potential terminal corresponding to the lowest potential of the N series battery modules, and N-1 intermediate potential terminals corresponding to N-1 intermediate potentials of the N series battery modules, the N+1 switches include:
a first switch connected to the highest potential terminal;
a second switch connected to the lowest potential terminal; and
the remaining N-1 switches connected to the N-1 intermediate potential terminals, respectively,
and wherein each of the N-1 switches comprises a pair of switching elements each having a charge carrier emitting region, a control region, and a charge carrier collection region, which correspond to the first, second, and third continuous semiconductor regions, respectively, the charge carrier emitting region of one of the pair of switching elements and that of the other of the pair of switching elements being commonly connected to each other.

3. A battery-pack voltage detection apparatus according to claim 2, wherein the first switch comprises a pair of switching elements each having a charge carrier emitting region, a control region, and a charge carrier collection region, which correspond to the fist, second, and third continuous semiconductor regions, respectively, the charge carrier emitting region of one of the pair of switching elements and that of the other of the pair of switching elements being commonly connected to each other.

4. A battery-pack voltage detection apparatus according to claim 2, wherein the second switch comprises a pair of switching elements each having a charge carrier emitting region, a control region, and a charge carrier collection region, which correspond to the first, second, and third continuous semiconductor regions, respectively, the charge carrier emitting region of one of the pair of switching elements and that of the other of the pair of switching elements being commonly connected to each other.

5. A battery-pack voltage detection apparatus according to 1, wherein at least one of the N+1 switches is a P-channel MOSFET, the P-channel MOSFET is connected to at least one of the N+1 potential terminals, and wherein at least one of the N+1 driving units is configured to bring the at least one of the N+1 potential terminals and another at least one of the N+1 potential terminals higher in potential than the at least one of the N+1 potential terminals into conduction to apply the potential at another at least one of the N+1 potential terminals to the gate of the P-channel MOSFET.

6. A battery-pack voltage detection apparatus according to claim 1, wherein at least one of the N+1 switches is an N-channel MOSFET, the N-channel MOSSES is connected to at least one of the N+1 potential terminals, and wherein at least one of the N+1 driving units is configured to bring the at least one of the N+1 potential terminals and another at least one of the N+1 potential terminals higher in potential than the at least one of the N+1 potential terminals into conduction to apply the potential at another at least one of the N+1 potential terminals to the gate of the N-channel MOSFET.

7. A battery-pack voltage detection apparatus according to claim 1, wherein at least one of the N+1 switches comprises a switching element having a charge carrier emitting region, a control region, and a charge carrier collection region, which corresponds to the first, second, and third continuous semiconductor regions, respectively, and wherein at least one of the N+1 driving units comprises:
a discharging element arranged between the charge carrier emitting region and the control region of the switching element of at least one of the N+1 switches; and
a control switch connected between the at least one of the N+1 potential terminals and the control region of the switching element of at least one of the N+1 switches.

8. A battery-pack voltage detection apparatus according to claim 7, wherein the switching element of at least one of the N+1 switches is PNP transistor, the PNP transistor of the at least one of the N+1 switches is connected to at least one of the N+1 potential terminals, and wherein the control switch is arranged between the control region of the PNP transistor of the at least one of the N+1 switches and another one of the N+1 potential terminals, another one of the N+1 potential terminals being lower in potential than at least one of the N+1 potential terminals.

9. A battery-pack voltage detection apparatus according to claim 7, wherein the switching element of at least one of the N+1 switches is NPN transistor, the NPN transistor of the at least one of the N+1 switches is connected to at least one of the N+1 potential terminals, and wherein the control switch is arranged between the control region of the NPN transistor of the at least one of the N+1 switches and another one of the N+1 potential terminals, another one of the N+1 potential terminals being lower in potential than at least one of the N+1 potential terminals.

10. A battery-pack voltage detection apparatus according to claim 7, wherein the control switch of at least one of the N+1 driving units is an optically electrical-isolation element.

11. A battery-pack voltage detection apparatus according to claim 7, wherein the control switches of at least two of the N+1 driving units have first and second control terminals, respectively, the first control terminals of the control switches being commonly connected to one of the N+1 potential terminals, the second control terminals of the control switches being connected to the control regions of at least two of the N+1 switches, respectively, and wherein at least two of the N+1 driving units are configured to individually apply a predetermined on voltage based on a potential of the one of the N+1 potential terminals to the discharging elements in at least two of the N+1 switches, the applied on voltage causing a voltage drop across each of the discharging elements, the voltage drop being higher than a threshold voltage of each of at least two of the N+1 switches, thereby tuning on each of the at least two of the N+1 switches.

12. A battery-pack voltage detection apparatus according to claim 2, wherein the N is an odd number, the first switch comprises at least one switching element having a p-type charge carrier emitting region, an n-type control region, and a p-type charge carrier collection region, which correspond to the first, second, and third continuous semiconductor regions, respectively, and the second switch comprises at least one switching element having an n-type charge carrier emitting region, a p-type control region, and an n-type charge carrier collection region, which corresponds to the first, second, and third continuous semiconductor regions, respectively.

13. A battery-pack voltage detection apparatus according to claim 2, wherein the N is an even number, and the first switch comprises at least one switching element having a p-type charge carrier emitting region, an n-type control region, and a p-type charge carrier collection region, which corresponds to the first, second, and third continuous semiconductor regions, respectively.

14. A battery-pack voltage detection apparatus according to claim 2, wherein the N is an even number, and the second switch comprises at least one switching element having an n-type charge carrier emitting region, a p-type control region, and an n-type charge carrier collection region, which correspond to the first, second, and third continuous semiconductor regions, respectively.

15. A battery-pack voltage detection apparatus connected to a battery pack, the battery pack comprising a plurality of battery modules connected in series, and a plurality of voltage output terminals connected to positive terminals of the battery modules, respectively, the battery-pack voltage detection apparatus comprising:
a voltage detection circuit connected to the plurality of voltage output terminals;
a plurality of switches each having at least a charge carrier emitting region, a control region, and a charge carrier collection region continuously arranged with alternating conductivity type; and
a plurality of current path fox circuits including charge carrier pull-out elements, each of the charge carrier pull-out elements connecting between the charge carrier emitting region and the control region of each of the switches, the current path forming circuits forming a plurality of current paths from the plurality of voltage output terminals through the plurality of charge carrier pull-out elements, respectively.

16. A battery-pack voltage detection apparatus according to claim 15, wherein each of the current path forming circuits includes a control switch operative to open/close the corresponding current path.

17. A battery-pack voltage detection apparatus connected to a battery pack, the battery pack comprising a plurality of battery modules connected in series; and a plurality of pairs of terminals, each pair of the terminals corresponding to a voltage output terminal of each of the battery modules, the battery-pack voltage detection apparatus comprising:
a voltage detection circuit with first and second input terminals, the voltage detection circuit being configured to detect a potential difference between the first and second terminals;
a voltage applying circuit having a plurality of switching elements connected between the terminals and any one of the first and second input terminals of the voltage detection circuit, respectively, each of the switching element having a control terminal connected to any one of the first and second input terminals thereof and operating to turn on/off based on a voltage applied to the control terminal, the voltage applying circuit being configured to:
selectively turn on any one pair of the switching elements to select any one pair in the plurality of pairs of terminals of the battery pack; and
connect the selected pair of the terminals to the first and second input terminals to apply a voltage of one of the battery modules corresponding to the selected pair of terminals to the voltage detection circuit; and
a reference voltage applying circuit connected to the first and second input terminals of the voltage detection circuit and configured to fix any one of the first and second input terminals to a predetermined reference voltage when the voltage applying circuit connects the selected pair to the first and second input terminals of the voltage detection circuit.

18. A battery-pack voltage detection apparatus according to claim 17, wherein the reference voltage applying circuit is configured to select any one of the first and second input terminals of the voltage detection circuit based on which swatches are selected by the voltage applying circuit.

19. A battery-pack voltage detection apparatus according to claim 18, wherein each of the switching elements includes a pair of MOS transistors each having a charge carrier emitting region, a control region, and a charge carrier collection region with alternating conductivity type, and the charge carrier collection region of one of the pair MOS transistors is connected to any one of the first and second input terminals of the of the voltage detection circuit, and wherein the reference voltage applying circuit is configured to apply the reference voltage to the charge carrier collection region of one of the paired MOS transistors.

20. A battery-pack voltage detection apparatus according to claim 17, further comprising a driving circuit configured to apply a control voltage to each of the switching elements, a voltage difference between the control voltage and the reference voltage allowing each of the switching elements to turn on.
